(19) United States
(12) Patent Application Publication
(10) Pub. No.: US 2024/0083274 A1
(43) Pub. Date: Mar. 14, 2024

(54) METHOD AND SYSTEM FOR CHARGING ELECTRIC VEHICLE OF CHARGING POSITION SELECTION TYPE BY USING NEW RENEWABLE ENERGY

(71) Applicant: FEC CO., LTD., Gyeongsan-si, Gyeongsangbuk-do (KR)

(72) Inventors: Sang Hwa LEE, Seoul (KR); Yoon Won LEE, Seoul (KR); Kyung Jin LEE, Seongnam-si, Gyeonggi-do (KR)

(73) Assignee: FEC CO., LTD., Gyeongsan-si, Gyeongsangbuk-do (KR)

(21) Appl. No.: 18/261,236

(22) PCT Filed: Jan. 19, 2022
(86) PCT No.: PCT/KR2022/000964

§ 371 Date: Jul. 12, 2023

(30) Foreign Application Priority Data
Jan. 26, 2021 (KR) 10-2021-0010613
Mar. 19, 2021 (KR) 10-2021-0036216

(51) Int. Cl. B60L 53/22; B60L 53/51; B60L 53/66; B60L 53/67

(52) U.S. Cl. CPC B60L 53/22; B60L 53/51; B60L 53/665; B60L 53/67; B60L 2210/10; B60L 2210/30; B60L 2240/70

(57) ABSTRACT

A system for charging an electric vehicle according to the present invention may comprise: a control unit for managing overall systems; an AC/DC converting system for primarily converting power input from a transformer into direct-current power; a new renewable generator for generating new renewable energy such as sunlight; an ESS for storing the generated energy; and a direct-current power delivery system for receiving the direct-current power, determining the stabilization and charging speed of a power source, and supplying charging power to the electric vehicle.

### TECHNICAL FIELD

The present disclosure relates to a charging system for an electric vehicle, which is capable of fixed charging or variable charging by using DC power, and, more particularly, to a technology for charging an electric vehicle which may be charged anywhere in a parking lot by converting AC power into DC power so that a charging speed, etc. requested by a charging wisher is provided to a location requested by the charging wisher. In other words, the present disclosure relates to an electric vehicle multi-charging system capable of providing corresponding power without any change or by changing or combining the corresponding power in order to transmit electricity that is approximate to a charging speed requested by a charging wisher.

### BACKGROUND ART

Conventionally, when an electric vehicle is charged, AC power is connected up to a charger. The charger supplies the electric vehicle with AC power in the case of slow charging, and supplies the electric vehicle with DC power by converting AC power into DC power in the case of quick charging.

If AC power is supplied to a charger as described above, efficiency is low because a power loss is great compared to DC power and an electric wire becomes thick and costs are increased because a current is high due to the use of a low AC voltage.

Furthermore, since kiosk must be installed around a parking space in order to charge the electric vehicle, a separate kiosk installation space is required and the electric vehicle can be charged only at a location where kiosk has been installed. Furthermore, there is a disadvantage in that when kiosk is installed, only a predetermined charging speed can be provided.

If a parking space dedicated to electric vehicles is increased for the charging of many electric vehicles, there are problems in that an installation cost for kiosk is increased and a wide space is required.

### DISCLOSURE

### Technical Problem

The present disclosure has been proposed in order to solve the problems of a conventional technology.

Specifically, the present disclosure is capable of including a transformer, an AC/DC converting system, a request power manipulation unit, a relay connection power grid, and an intra-parking lot power grid, and an object of the present disclosure is to provide an electric vehicle with charging power via a relay connection power grid and an intra-parking lot power grid within a building without a little power loss compared to AC power by installing the transformer, the AC/DC converting system, and the request power manipulation unit outside a building and converting AC power into DC power.

Furthermore, the request power manipulation unit selects and transmits power approximate to a charging speed based on the charging speed requested by a charging wisher, or provides the power approximate to the charging speed by changing or combining the power as corresponding power. The thickness of an electric wire becomes thin because a DC voltage higher than AC power is used and a relatively low current flows. An object of the present disclosure is to provide charging power so that an electric vehicle can be charged at any place without installing separate kiosk through a relay connection grid and an intra-parking lot power grid.

Technical objects to be achieved by the present disclosure are not limited to the aforementioned objects, and the other objects not described above may be evidently understood from the following description by a person having ordinary knowledge in the art.

### Technical Solution

A charging system for an electric vehicle according to the present disclosure may include a control unit configured to manage overall systems; an AC/DC converting system configured to primarily convert power input from a transformer into DC power; a new renewable generator configured to generate new renewable energy, such as sunlight; an ESS configured to store the generated energy; and a DC power delivery system configured to stabilize power and determine a charging speed by receiving the DC power and to supply charging power up to an electric vehicle.

The control unit may include a main control apparatus that plays a role to manage and control overall systems, to perform internal communication, and to transmit notification to a terminal of a charging wisher or receive information from the terminal by controlling a customer reception system.

The control unit may include an allowed power quantity management apparatus for consistently monitoring and controlling power used for charging so that the power does not exceed acceptable power in the transformer.

The control unit may include AC/DC converting system management for consistently monitoring and controlling the AC/DC converting system so that acceptable power that is determined when the AC power supplied by the transformer is converted into the DC power is not exceeded.

The control unit may include power system management in which the supply of DC power of a battery of the ESS to the DC power delivery system or the reselling of surplus electric power is controlled and power to be used in the DC power delivery system is controlled based on several factors, such as electric charges for each time zone, the amount of remaining power of a battery of the ESS, etc.

The control unit may include request power manipulation unit management for generally controlling a current fixed type DC/DC converter or a current variable DC/DC converter in order to provide a charging speed requested by a charging wisher and performing control, such as varying or combining the current fixed type DC/DC converter or the current variable DC/DC converter based on the charging speed.

The control unit may include charging electric-wire connection management for forming a charging path for a charging speed from a request power manipulation unit to a location where the electric vehicle is present.

The control unit may include a customer reception system for the management of member information of a charging wisher, charge information for each external time zone/each season, a degree of diagnosis of a charging target vehicle, communication with a charging wisher, etc.

The control unit may include charging target vehicle charging and management for managing information, such as a battery state, the amount of remaining battery power, and vehicle information of a charging target vehicle, which are received from the charging target vehicle, and information, such as whether a vehicle is a vehicle which may be charged in a corresponding charging system.

The DC power delivery system may include a connection power grid for forming a charging path with the request power manipulation unit for providing a charging speed of a charging wisher.

The request power manipulation unit may include a current fixed type DC/DC converter or a current variable DC/DC converter for providing a charging speed, an open circuit connection switch for providing or blocking requested power, a multi-connection switch for combining requested power, a request power manipulation electric wire, a socket, and a request power provision electric wire for supplying a charging speed.

The connection power grid may include a relay connection power grid that forms a path in order to supply a charging speed supplied by the request power manipulation unit to an intra-parking lot power grid.

The connection power grid may include an intra-parking lot power grid that forms a path in order to supply, up to an electric vehicle, a charging speed that is supplied through a relay connection power grid.

The connection power grid may include a multi-connection switch and electric wires for forming a path between the request power manipulation unit and the intra-parking lot power grid.

The intra-parking lot power grid may include a multi-connection switch, a power grid, and a charging adapter for forming a path up to an electric vehicle within a parking lot.

### Advantageous Effects

As described above, the charging system for an electric vehicle according to the present disclosure includes the transformer, the control unit managing overall systems, the AC/DC converting system primarily converting unstable AC power received from the transformer into DC power, and the DC power delivery system for providing a charging speed requested by a charging wisher.

The system may be fabricated to further include the new renewable generator configured to generate new renewable energy, such as sunlight and the ESS configured to store generated energy.

Furthermore, there is an effect in that various charging speeds are provided in a way that the request power manipulation unit changes an output current through the current variable DC/DC converter based on a charging speed requested by a charging wisher, a current fixed type DC/DC converter similar to the charging speed outputs the output current, or the charging speed is provided through a combination of the current fixed type DC/DC converters.

Furthermore, there is an advantage in that slow charging to quick charging using DC power can be provided depending on a construction of the DC/DC converter because various charging speeds can be provided.

Furthermore, since DC power is used as main use power, there are effects in that efficiency is high because a power loss is small compared to a case in which AC power is used and a cost can be reduced by using a thin electric wire because a current that flows into the electric wire is low compared to the same power.

Furthermore, there are effects in that a space necessary for charging can be reduced and a cost can be reduced compared to the installation of kiosk because charging is possible in any space in which an intra-parking lot power grid has been formed without the installation of a separate large kiosk as in a conventional technology.

Furthermore, there is an advantage in that charging can be performed in all parking spaces in which an intra-parking lot power grid has been installed without moving the internal combustion engine vehicle that has been parked, in addition to charging only around kiosk as in a conventional technology.

### BRIEF DESCRIPTION OF DRAWINGS

FIG. 1 is a diagram illustrating a general block diagram of a system with which new renewable energy has been combined according to an embodiment of the present disclosure.

FIG. 2A is a diagram illustrating a detailed construction (a) of a system including an AC/DC converting system (b), a new renewable generator such as sunlight, an ESS, a DC power delivery system (c), a request power manipulation unit (a), a relay connection power grid (a), and an intra-parking lot power grid (a) according to an embodiment of the present disclosure.

FIG. 2B is a diagram illustrating a detailed construction (b) of a system including an AC/DC converting system (b), a new renewable generator such as sunlight, an ESS, a DC power delivery system (c), a request power manipulation unit (d), a selective connection switch, a relay connection power grid (c), and an intra-parking lot power grid (b) according to an embodiment of the present disclosure.

FIG. 2C is a diagram illustrating a detailed construction (c) of a system in which a DC/DC converter of a request power manipulation unit is included in the AC/DC converting system and an AC/DC converter and the DC/DC converter are connected in a one-to-one way and which include a new renewable generator such as sunlight, an ESS, a DC power delivery system (c), a request power manipulation unit (a), a relay connection power grid (a), and an intra-parking lot power grid (a) according to an embodiment of the present disclosure.

FIG. 2D is a diagram illustrating a detailed construction (d) of a system in which a relay connection power grid is not present, a request power manipulation unit is disposed near an intra-parking lot power grid within a building, and a DC/DC converter of an AC/DC converting system and a DC/DC converter of the request power manipulation unit are connected in a one-to-many way and which includes a new renewable generator such as sunlight, an ESS, a DC power delivery system (c), a request power manipulation unit (a), and an intra-parking lot power grid (a) according to an embodiment of the present disclosure.

FIG. 2E is a diagram illustrating a detailed construction (d) of a system in which a relay connection power grid is not present, a request power manipulation unit is disposed near an intra-parking lot power grid within a building, and a DC/DC converter of an AC/DC converting system and a DC/DC converter of the request power manipulation unit are connected in a one-to-many way, several intra-parking lot power grids are constructed and which include a new renewable generator such as sunlight, an ESS, a DC power delivery system (c), a request power manipulation unit (a), and an intra-parking lot power grid (a) according to an embodiment of the present disclosure.

FIG. 3A is a diagram illustrating a flowchart (a) in the case of the request power manipulation unit (a) according to an embodiment of the present disclosure.

FIG. 3B is a diagram illustrating a flowchart (b) in the case of the request power manipulation unit (b) according to another embodiment of the present disclosure.

FIG. 3C is a diagram illustrating a flowchart (c) in the case of the request power manipulation unit (c) according to still another embodiment of the present disclosure.

FIG. 3D is a diagram illustrating a flowchart (d) in the case of the request power manipulation unit (d) according to still another embodiment of the present disclosure.

FIG. 3E is a diagram illustrating a flowchart (e) in the case of a request power manipulation unit (e) according to still another embodiment of the present disclosure.

FIG. 4A is a diagram illustrating an AC/DC converting system (a) in which one AC/DC converting system is constructed according to an embodiment of the present disclosure.

FIG. 4B is a diagram illustrating an AC/DC converting system (b) in which several AC/DC converting systems are constructed according to an embodiment of the present disclosure.

FIG. 5A is a diagram illustrating a DC power delivery system (a) in which one DC power delivery system is constructed in one AC/DC converting system according to an embodiment of the present disclosure.

FIG. 5B is a diagram illustrating a DC power delivery system (b) in which several DC power delivery systems are constructed in one AC/DC converting system according to an embodiment of the present disclosure.

FIG. 5C is a diagram illustrating a DC power delivery system (c) in which a DC power delivery system is constructed in each of several AC/DC converting systems according to an embodiment of the present disclosure.

FIG. 5D is a diagram illustrating a DC power delivery system (d) in which several DC power delivery systems are constructed and the DC power delivery systems exchange surplus power according to an embodiment of the present disclosure.

FIG. 6A is a diagram illustrating a request power manipulation unit (a) using a method of determining the number of current fixed type DC/DC converters based on the number of simultaneously chargeable electric vehicles and determining a charging speed without a change based on generated power of the current fixed type DC/DC converters according to an embodiment of the present disclosure.

FIG. 6B is a diagram illustrating a request power manipulation unit (b) using a method of determining the number of current fixed type DC/DC converters based on the number of simultaneously chargeable electric vehicles and determining a charging speed without a change based on generated power of the current fixed type DC/DC converters, but using a method of additionally connecting some current fixed type DC/DC converters in parallel and providing requested power through a combination of a horizontal request power manipulation electric wire and a vertical request power manipulation electric wire by using a multi-connection switch in response to a request from a charging wisher according to an embodiment of the present disclosure.

FIG. 6C is a diagram illustrating a request power manipulation unit (c) using a method of determining the number of current variable DC/DC converters based on the number of simultaneously chargeable electric vehicles and determining a charging speed by changing generated power of the current variable DC/DC converters based on requested power of a charging wisher according to an embodiment of the present disclosure.

FIG. 6D is a diagram illustrating a request power manipulation unit (d) using a method capable of supplying power to any point by connecting a socket to each point at which a horizontal request power manipulation electric wire and a vertical request power manipulation electric wire are intersected and connecting a request power provision electric wire to the socket in the method of the request power manipulation unit (b) according to an embodiment of the present disclosure.

FIG. 6E is a diagram illustrating a request power manipulation unit (e) using a method of determining the number of current fixed type DC/DC converters based on the number of simultaneously chargeable electric vehicles, supplying generated power of the current fixed type DC/DC converters by using an additional current variable DC/DC converter if a current fixed type DC/DC converter corresponding to requested power of a charging wisher is present, setting a charging speed in the current variable DC/DC converter if the corresponding current fixed type DC/DC converter is not present, and supplying the generated power of the current fixed type DC/DC converters according to an embodiment of the present disclosure.

FIG. 7A is a diagram illustrating a relay connection power grid (a) in which a relay connection power grid is constructed in a pyramid form according to an embodiment of the present disclosure.

FIG. 7B is a diagram illustrating a relay connection power grid (b) in which a relay connection power grid is constructed in a grid form according to an embodiment of the present disclosure.

FIG. 7C is a diagram illustrating a relay connection power grid (c) in which a relay connection power grid is constructed in an inverted pyramid form according to an embodiment of the present disclosure.

FIG. 7D is a diagram illustrating a relay connection power grid (d) in which a top connection power grid of a relay connection power grid is connected to a request power provision electric wire of a request power manipulation unit in a one-to-one way according to an embodiment of the present disclosure.

FIG. 7E is a diagram illustrating a relay connection power grid (e) in which a top connection power grid of a relay connection power grid is connected to a request power provision electric wire of a request power manipulation unit in a way that one top connection power grid is skipped per two request power provision electric wires according to an embodiment of the present disclosure.

FIG. 7F is a diagram illustrating a relay connection power grid (f) in which a top connection power grid of a relay connection power grid is connected to a request power provision electric wire of a request power manipulation unit in a way that one top connection power grid is skipped per one request power provision electric wire according to an embodiment of the present disclosure.

FIG. 8A is a diagram illustrating an intra-parking lot power grid (a) in which an electric wire to which the relay connection power grid and the intra-parking lot power grid are connected is connected to a top multi-connection switch line according to an embodiment of the present disclosure.

FIG. 8B is a diagram illustrating an intra-parking lot power grid (b) in which an electric wire to which a relay connection power grid and an intra-parking lot power grid are connected is connected to a top multi-connection switch line and a left-end or right-end multi-connection switch line according to an embodiment of the present disclosure.

FIG. 8C is a diagram illustrating an intra-parking lot power grid (c) in which an electric wire to which the relay connection power grid and the intra-parking lot power grid are connected is connected to all of a top multi-connection switch line, a left-end multi-connection switch line, and a right-end multi-connection switch line according to an embodiment of the present disclosure.

FIG. 8D is a diagram illustrating an intra-parking lot power grid (d) in which a form of an intra-parking lot power grid is changed due to an obstacle, such as a wall, in the connection method of the intra-parking lot power grid (c) according to an embodiment of the present disclosure.

FIG. 9 is a diagram illustrating an example of an internal structure of a multi-connection switch according to one embodiment of the present disclosure.

FIG. 10A is a diagram illustrating an example of the connection of a multi-connection switch according to an embodiment of the present disclosure and an example (a) of the connection of the multi-connection switch in the state in which any internal switch has not been connected to the multi-connection switch because all of the internal switches do not operate.

FIG. 10B is a diagram illustrating an example of the connection of the multi-connection switch according to an embodiment of the present disclosure and an example (b) of the connection of the multi-connection switch in the state in which the top and bottom of the multi-connection switch, among internal switches, have been connected.

FIG. 10C is a diagram illustrating an example of the connection of the multi-connection switch according to an embodiment of the present disclosure and an example (c) of the connection of the multi-connection switch in the state in which a left end and right end of the multi-connection switch, among internal switches, have been connected.

FIG. 10D is a diagram illustrating an example of the connection of the multi-connection switch according to an embodiment of the present disclosure and an example (d) of the connection of the multi-connection switch in the state in which the top and left end of the multi-connection switch, among internal switches, have been connected.

FIG. 10E is a diagram illustrating an example of the connection of the multi-connection switch according to an embodiment of the present disclosure and an example (e) of the connection of the multi-connection switch in the state in which the bottom and left end of the multi-connection switch, among internal switches, have been connected.

FIG. 10F is a diagram illustrating an example of the connection of the multi-connection switch according to an embodiment of the present disclosure and an example (f) of the connection of the multi-connection switch in the state in which the top and right end of the multi-connection switch, among internal switches, have been connected.

FIG. 10G is a diagram illustrating an example of the connection of the multi-connection switch according to an embodiment of the present disclosure and an example (g) of the connection of the multi-connection switch in the state in which the bottom and right end of the multi-connection switch, among internal switches, have been connected.

FIG. 11 is a diagram illustrating an example of a selective connection switch system according to an embodiment of the present disclosure.

### MODE FOR INVENTION

In this document, a “charging wisher” means a person who wishes charging, and a “charging target vehicle” means a vehicle to be charged.

Furthermore, a “current fixed type D/D” means a current fixed type DC/DC converter, a “current variable type D/D” means a current variable DC/DC converter, and a “D/D” means a DC/DC converter.

Furthermore, a “selective connection system” means that a system performs a selective connection. A “DC power delivery system” is a name that refers to both a request power manipulation unit and a connection power grid. A “connection power grid” is a name that refers to both a relay connection power grid and an intra-parking lot power grid.

Furthermore, terms including ordinal numbers, such as a “first” and a “second”, and terms including letters, such as (a) and (b), may be used to describe various components, but the components are not restricted by the terms. The terms are used to only distinguish one element from the other elements.

Furthermore, “corresponding” is for the number of simultaneously chargeable electric vehicles and the number of D/Ds. The number of simultaneously chargeable electric vehicles and the number of D/Ds may have the ratio of 1 to 1. In an embodiment of the present disclosure, the number of D/Ds may be greater than the number of simultaneously chargeable electric vehicles.

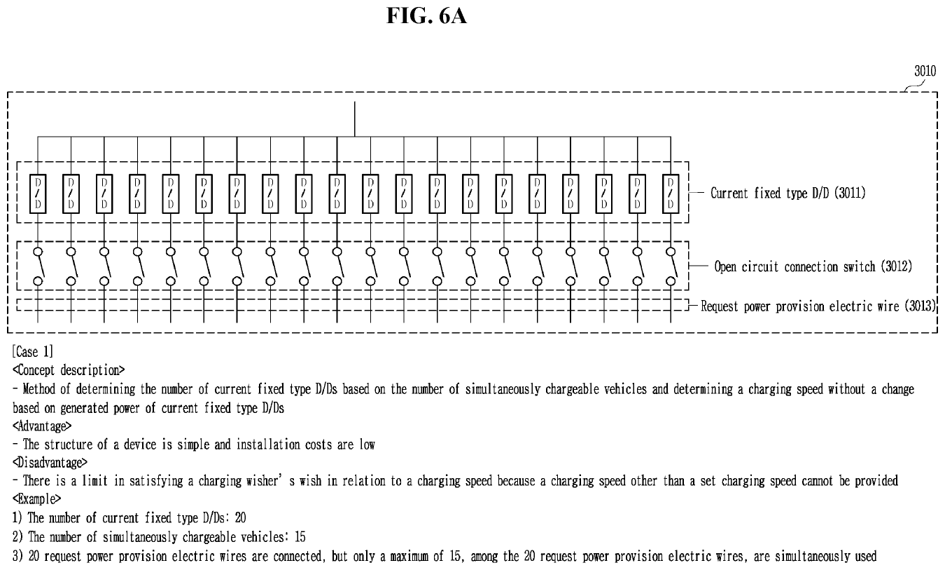

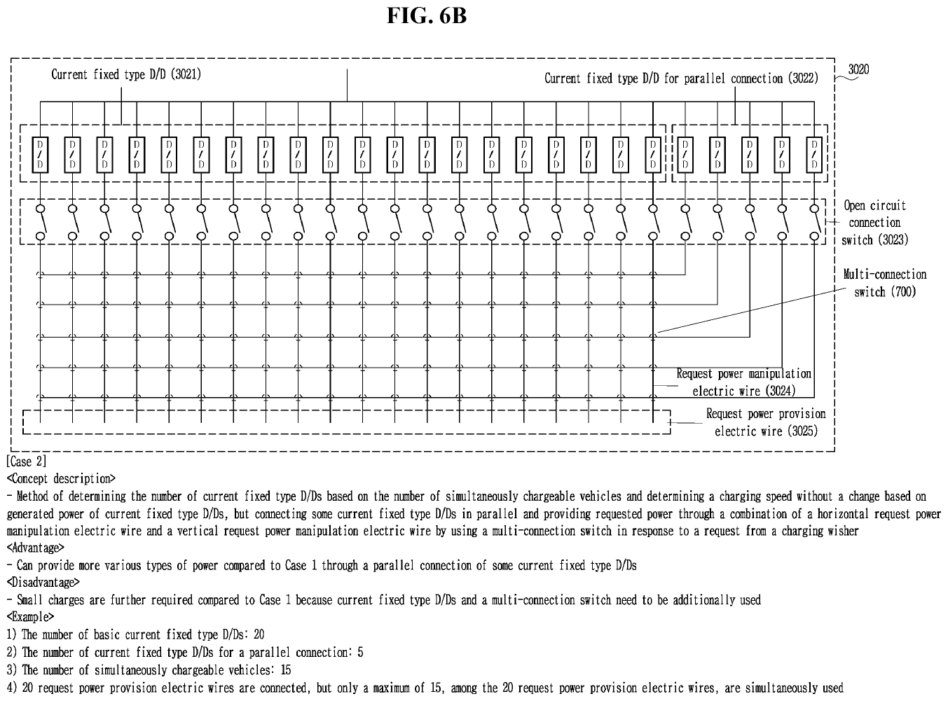

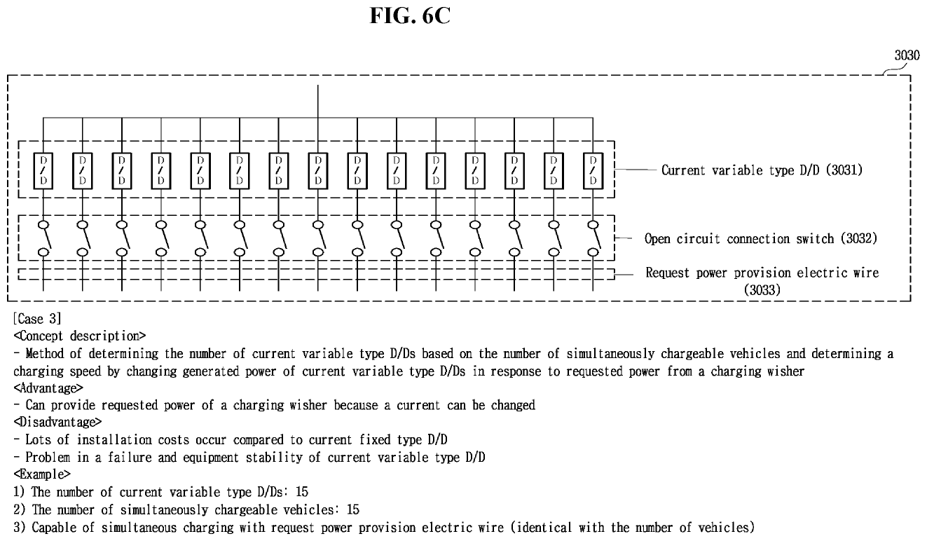

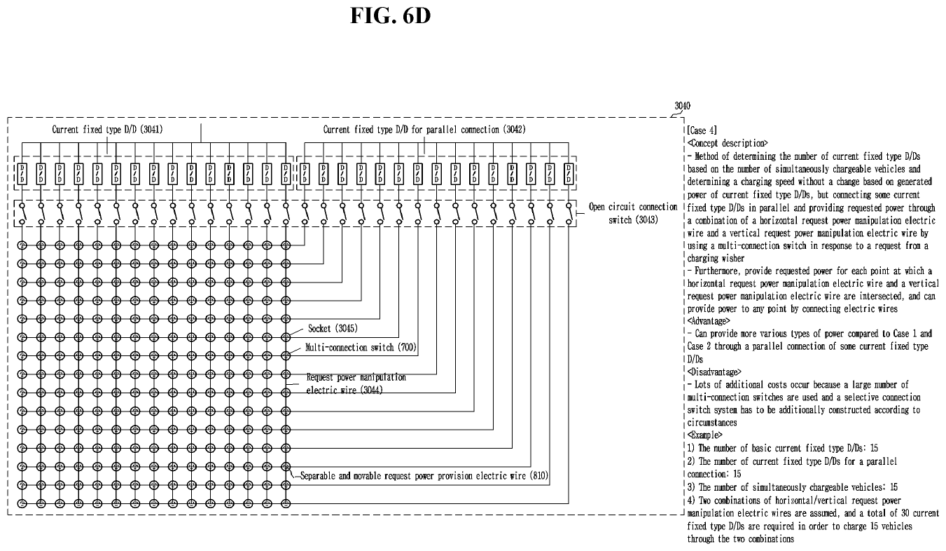

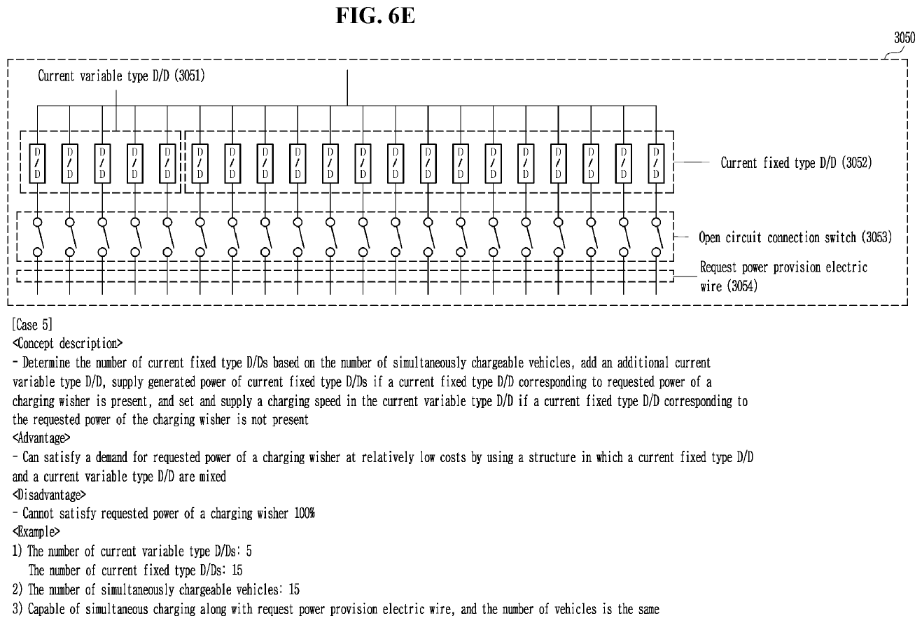

Furthermore, in the “corresponding”, in relation to the number of simultaneously chargeable electric vehicles and the number of D/Ds, the number of D/Ds may be greater than the number of simultaneously chargeable electric vehicles for a parallel connection as in FIGS. 6B and 6D according to an embodiment of the present disclosure, an additional extension may be considered in constructions of FIGS. 6A, 6C, and 6E, or the number of D/Ds may be greater than the number of simultaneously chargeable electric vehicles for the diversity of a charging speed (requested power) which may be selected by a charging wisher.

Furthermore, in the “corresponding”, the number of D/Ds may be smaller than the number of simultaneously chargeable electric vehicles depending on a construction for a charging speed of a D/D. In a charging system according to the present disclosure, although there is a D/D that is not used when the amount of power used reaches the amount of power permitted, the D/D may not be used because the amount of power used cannot exceed the amount of power permitted.

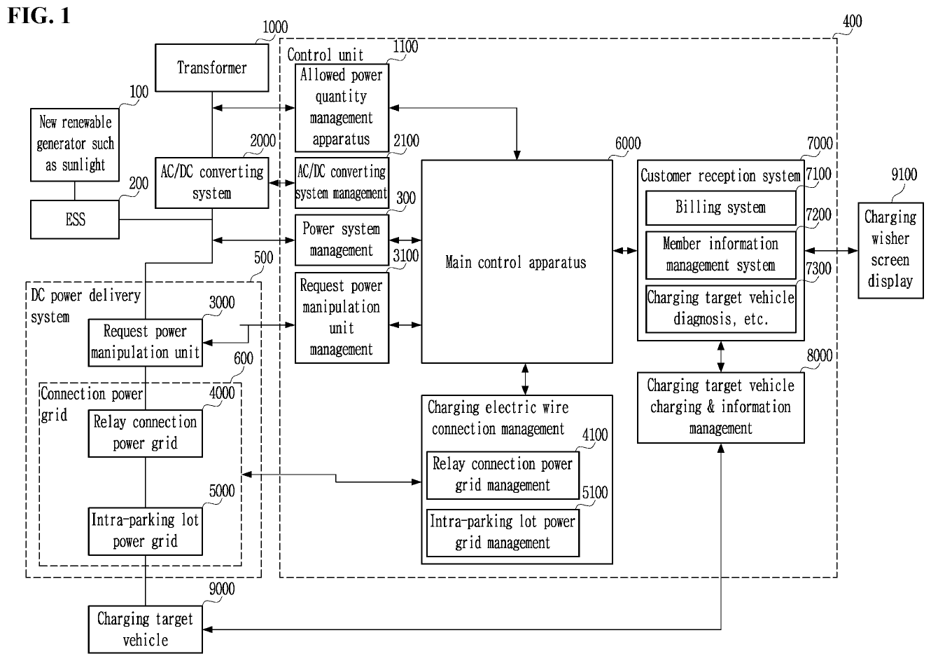

A general block diagram of a system according to an embodiment of the present disclosure includes a transformer 1000, an AC/DC converting system 2000, a new renewable generator such as sunlight, an ESS, a DC power delivery system 500, a charging target vehicle 9000, a charging wisher screen display 9100, and a control unit 400, as illustrated in FIG. 1.

In an embodiment of the present disclosure, the transformer 1000 is indicated, but the corresponding name may include pieces of equipment that is necessary for a process for power reception, power distribution, and transformation in general, such as power reception and distribution equipment, including power reception for receiving power generated by a power plant and a power distribution for distributing the power as the amount of power that is necessary for a consumer, power transformation equipment for power transformation, a panel board, etc.

The size of an AC voltage that is transformed by the transformer 1000 may be different depending on the size of a DC voltage of power generated by a power plant, which is used by the DC power delivery system 500. The size of an AC voltage that is transformed is determined by considering transformation efficiency, etc.

Furthermore, in an embodiment of the present disclosure, AC power that is generated by a power plant is basically described, but pieces of equipment for converting supplied DC power may be included if the power is supplied to high voltage DC transmission (HVDC) that recently attracts attention.

Furthermore, if required proper electricity is present on the outside, the electricity may be used without any change. In this case, the transformer may not be included in the system of the present disclosure. In this case, a transformer which may be disposed somewhere on the outside becomes the transformer of the present disclosure. However, in most cases, it may be said that the transformer is disposed within the system.

Power that is supplied from the outside is transformed by the transformer 1000. The power that is transformed as described above is supplied to the AC/DC converting system 2000. The AC/DC converting system 2000 plays a role to primarily convert AC power supplied by the transformer into DC power and supply the DC power.

Power that is input to the transformer via processes, such as a power plant, power transmission, and power distribution, is unstable. If power that is unstable as described above is directly converted into and used as a DC voltage, a problem, such as a malfunction or deterioration, may occur because unstable power is supplied.

AC power is primarily converted into DC power through the AC/DC converting system 2000. The converted DC power is stabilized in a request power manipulation unit 3000 through DC/DC conversion, and may be used upon charging of the charging target vehicle 9000.

A new renewable generator 100, such as sunlight, may include new renewable generators, such as solar energy generation and wind power generation. Solar energy generation is described as an example. Solar energy generation is a generation method of generating power by converting sunlight into DC electricity, and can generate power by using a solar panel to which several solar cells have been attached.

The solar panel has its output voltage determined depending on a construction of the solar cells and has a different current generated depending on the intensity of light. Power that is generated depending on the intensity of light is continuously changed. The charging system according to the present disclosure needs to supply a charging speed (requested power) requested by a charging wisher, and can supply a stable charging speed (requested power) by storing power generated by the solar energy generation in the ESS 200.

If power generated as in the solar energy generation is DC, the power is converted and stored in accordance with a charging voltage of the ESS 200 by using a DC/DC converter. If power generated as in the wind power generation is AC, the power is stored by using an AC/DC converter. In the example, the solar energy generation and the wind power generation have been described as examples, but the present disclosure is not limited to a corresponding generation method and various types of new renewable energy generation may be used.

The ESS 200 means an energy storage system, and may include several apparatuses for constructing the ESS 200, such as a battery, a battery management system (BMS), and a power management system (PMS). Apparatuses may be added or omitted if necessary.

The ESS 200 may be charged with new renewable energy, and may be charged during daytime when solar energy generation, for example, is used, but may be charged with power that is supplied by the AC/DC converting system 2000 if the ESS cannot be charged normally at night or in a dark day or in a time zone in which electric charges are cheap.

Furthermore, the output voltage of a battery of the ESS 200 may be the same as a voltage that is used in the DC power delivery system 500. If the output voltage is different from the voltage that is used in the DC power delivery system 500, the voltage may be supplied after being converted into the voltage that is used in the DC power delivery system 500 by using a D/D.

Power system management 300 plays a role to control power to be used according to circumstances, such as supplying power of the AC/DC converting system 2000 to the DC power delivery system 500 or supplying energy stored in the ESS 200 to the DC power delivery system 500.

Furthermore, the power system management 300 may charge the battery of the ESS 200 with power that is supplied by the AC/DC converting system 2000 when the amount of remaining charging power of the ESS 200 is small. In contrast, the power system management 300 performs control, such as selling energy stored in the ESS 200 to an electricity supply company in a time zone in which electric charges are expensive.

Furthermore, the AC/DC converting system 2000 basically plays a role to primarily convert AC power that is supplied by the transformer into DC power and to supply the converted DC power, but may also play a role to convert DC power into AC power in order to resell energy stored in the ESS 200 to an electricity supply company.

The DC power delivery system 500 may include the request power manipulation unit 3000 and a connection power grid 600. The connection power grid 600 may include a relay connection power grid 4000 and an intra-parking lot power grid 5000.

The request power manipulation unit 3000 performs control, such as the selection of a D/D or a combination of D/Ds and the setting of a charging speed (requested power) in order to provide the charging speed (requested power) of a charging wisher, and plays a role to supply a charging speed (requested power) or release the supply of a charging speed (requested power).

In this case, the charging speed of the charging wisher includes a set speed that has been previously agreed or published although the charging speed has not been requested at that time. Furthermore, the system may autonomously apply a proper time and charging speed depending on a forwarding time of a charging wisher, which may be included in the meaning of the charging speed of the charging wisher in that a charging time and a charging speed have been determined based on the will of the charging wisher.

The relay connection power grid 4000 is disposed between a request power provision electric wire 3013, 3025, 3033, and 3054 (hereinafter 3013) that supplies a charging speed (requested power) set in the request power manipulation unit 3000 and the intra-parking lot power grid 5000, and is used to form a path so that a charging speed (requested power) is supplied up to the intra-parking lot power grid 5000 along a proper path.

The intra-parking lot power grid 5000 is connected to the relay connection power grid 4000, and plays a role to provide a charging speed (requested power) by forming a charging path up to a location where the charging target vehicle 9000 is present.

The charging target vehicle 9000 means a vehicle to be charged, and is supplied with a charging speed (requested power) requested by a charging wisher via the request power manipulation unit 3000, the relay connection power grid 4000, and the intra-parking lot power grid 5000.

The control unit 400 includes a main control apparatus 6000, an allowed power quantity management apparatus 1100, AC/DC converting system management 2100, request power manipulation unit management 3100, relay connection power grid management 4100, intra-parking lot power grid management 5100, charging target vehicle charging and information management 8000, and a customer reception system 7000.

The main control apparatus 6000 plays a role to transmit notification to or transmit and receive information to and from a terminal of a charging wisher through the management and control of overall systems for charging, internal or external communication, and control of the customer reception system 7000.

Various methods for wired communication or wireless communication, such as PLC, a CAN, a LAN, a LIN, Bluetooth, ZigBee, and Beacon, may be used as communication methods that are used to perform internal or external communication in the main control apparatus 6000.

The allowed power quantity management apparatus 1100 plays a role to consistently monitor and control power that is used in the charging system according to the present disclosure so that the power does not exceed total power that is acceptable for the transformer 1000. To this end, in general, the allowed power quantity management apparatus 1100 may include equipment, software, or a panel board for monitoring and controlling power.

In this case, the acceptable total power may mean, in principle, the amount of power that is permitted according to a contract with an electricity supply source (KEPCO, etc. in Korea) regardless of whether a transformer is present or not.

The AC/DC converting system management 2100 plays a role to consistently monitor and control power that is supplied by the transformer 1000 so that the supplied power does not exceed power that is determined when the supplied power is primarily converted into DC power. In general, the AC/DC converting system management 2100 may include equipment, software, or a panel board for monitoring and controlling power.

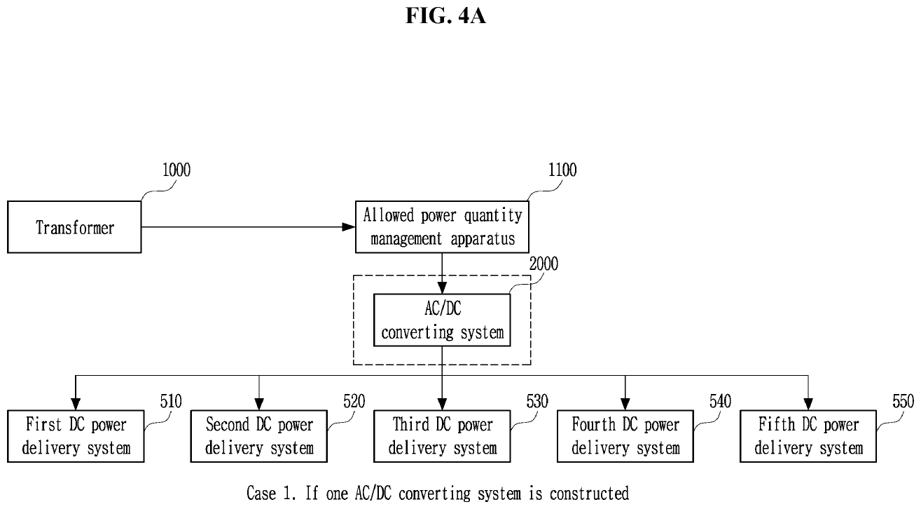

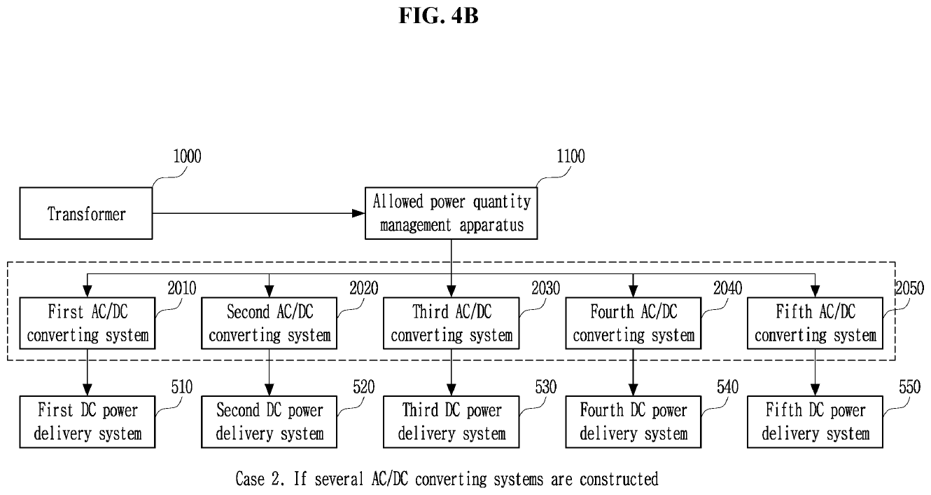

If not one AC/DC converting system, but several AC/DC converting systems are constructed as in FIG. 4B, the AC/DC converting system management 2100 may monitor and control each of AC/DC converting systems 2010, 2020, 2030, 2040, and 2050.

The request power manipulation unit management 3100 plays a role to perform control, such as selecting or combining D/Ds in response to a request from a charging wisher or determining and supplying or blocking a charging speed (requested power), and to identify problems, such as a breakdown and the leakage current.

The relay connection power grid management 4100 plays a role to form a path for supplying a charging speed (requested power) set in the request power manipulation unit 3000 up to the intra-parking lot power grid 5000 in which the charging target vehicle 9000 has been disposed and to release the forming of the path after charging is completed.

The intra-parking lot power grid management 5100 plays a role to form a path for supplying a charging speed (requested power) that is supplied by the relay connection power grid 4000 up to a location of the charging target vehicle 9000 and to release the forming of the path after charging is completed.

The charging target vehicle charging and information management 8000 plays a role to determine information, such as battery information, the amount of remaining battery power, and vehicle information that are received from the charging target vehicle 9000, and whether the charging target vehicle 9000 that is connected to a corresponding charging system is a vehicle which may be charged in the corresponding charging system.

The customer reception system 7000 includes a billing system 7100, a member information management system 7200, and charging target vehicle diagnosis, etc. 7300. In an embodiment according to the present disclosure, the customer reception system 7000 is described by being divided into the three types, but this is an example. When a system is constructed, the system may be added, if necessary.

The billing system 7100 plays a role to calculate and pay a bill according to bill information for each time zone/each season and power used for charging. The member information management system 7200 may play a role to store payment information, vehicle information, schedule information, etc. of a charging wisher.

The charging target vehicle diagnosis, etc. 7300 may play a role to store information that is received from the charging target vehicle charging and information management 8000 and to deliver the information to a charging wisher depending on information.

The charging wisher screen display 9100 means that information that is transmitted by the customer reception system 7000 is displayed on a terminal, such as a smartphone or computer of a charging wisher.

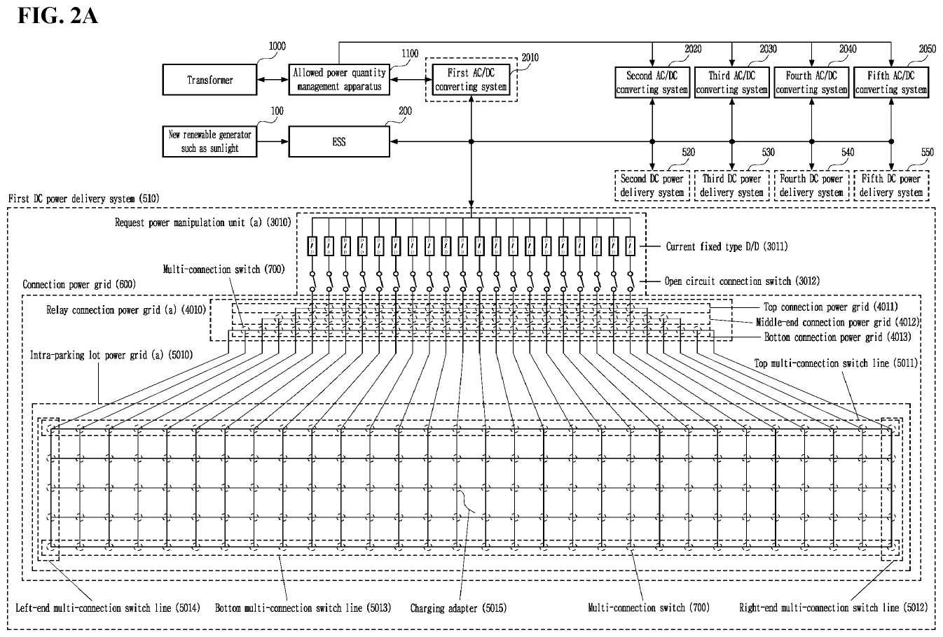

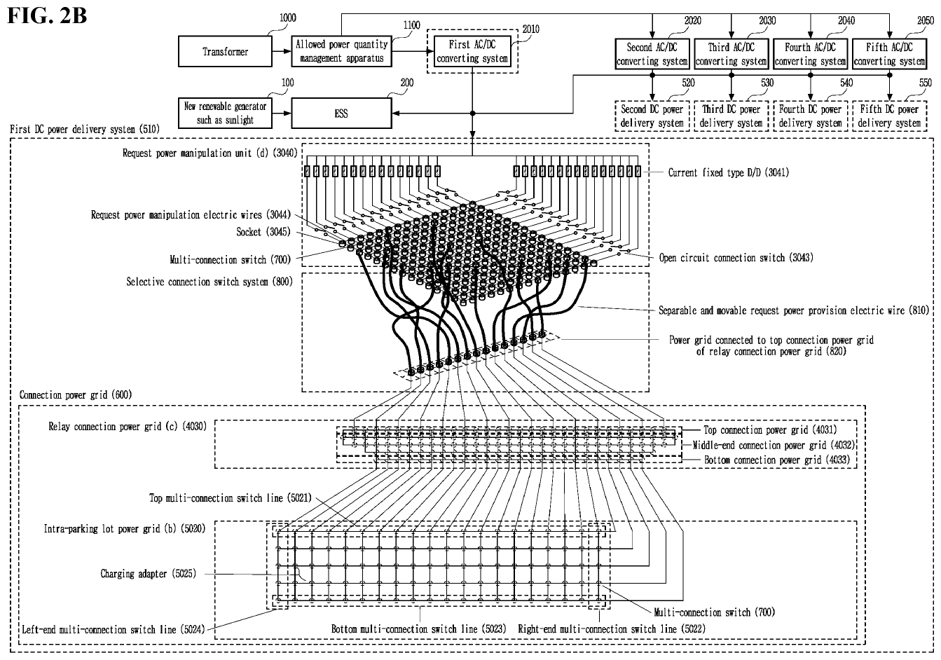

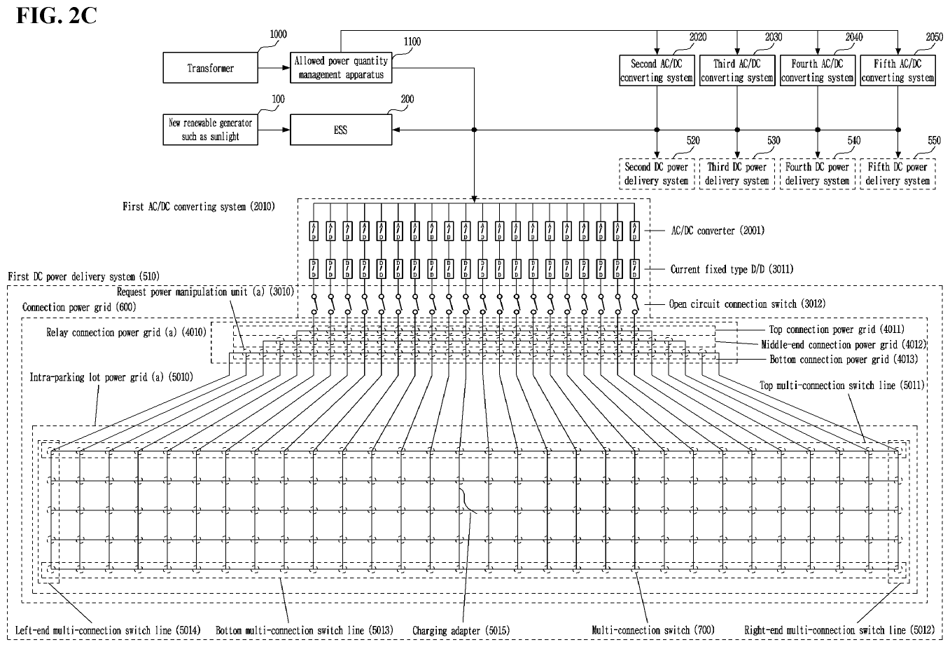

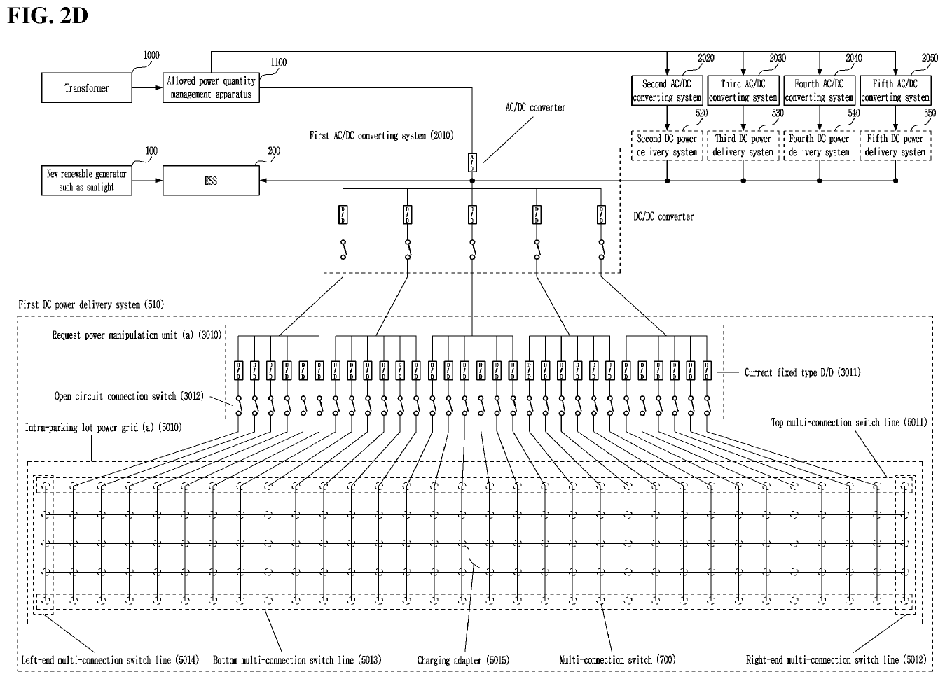

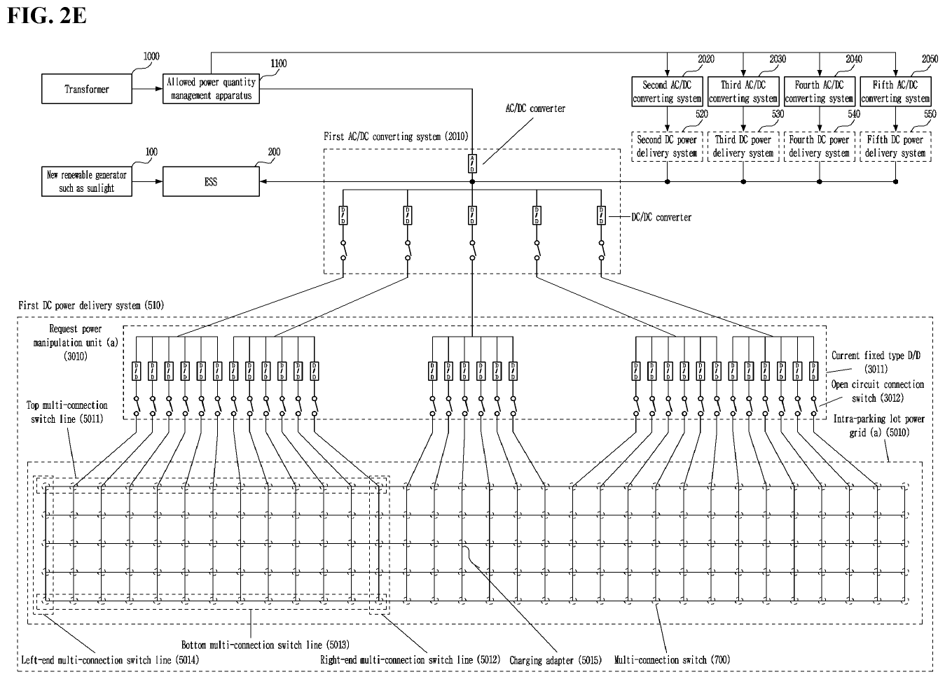

FIG. 2A represents, as an example, a general structure from the transformer 1000 to a charging adapter 5015 at a place where the charging target vehicle 9000 has been disposed according to an embodiment of the present disclosure, and includes the transformer 1000, the allowed power quantity management apparatus 1100, the AC/DC converting system 2000, the new renewable generator 100 such as sunlight, the ESS 200, and the DC power delivery system 500.

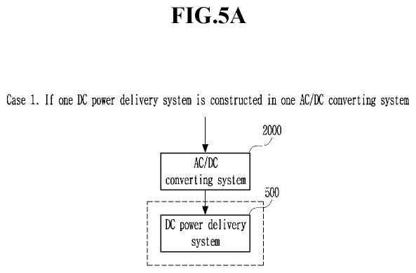

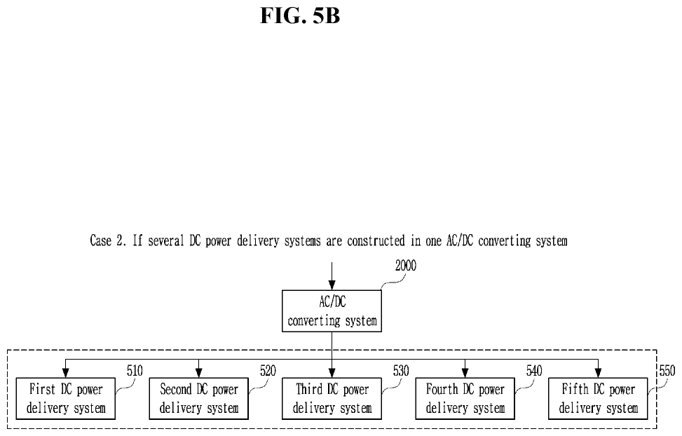

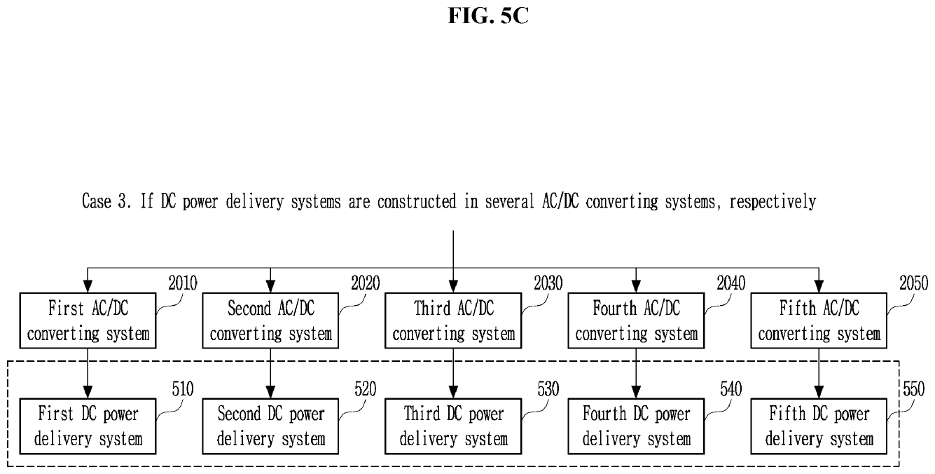

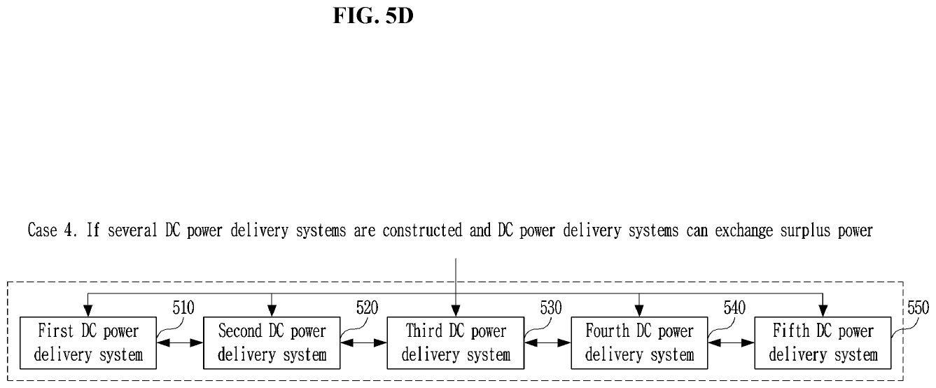

In FIG. 2A, the AC/DC converting system 2000 includes first to fifth AC/DC converting systems 2010, 2020, 2030, 2040, and 2050 as in FIG. 4B. The DC power delivery system 500 has a construction in which first to fifth DC power delivery systems 510, 520, 530, 540, and 550 are connected to the first to fifth AC/DC converting systems 2010, 2020, 2030, 2040, and 2050, respectively, as in FIG. 5C.

In FIGS. 4B and 5C, five AC/DC converting systems 2000 and five DC power delivery systems 500 are constructed, but this is merely an example according to an embodiment of the present disclosure, and each of the number of AC/DC converting systems and the number of DC power delivery systems may be greater or smaller than 5.

FIG. 2A has been described by taking, as an example, the first AC/DC converting system 2010 and the first DC power delivery system 510, among the first to fifth AC/DC converting systems 2010, 2020, 2030, 2040, and 2050 and the first to fifth DC power delivery systems 510, 520, 530, 540, and 550.

DC power that is generated by the first to fifth AC/DC converting systems 2010, 2020, 2030, 2040, and 2050 and DC power of the first to fifth DC power delivery systems 510, 520, 530, 540, and 550 may use DC power having the same size, and may use DC power having different sizes, if necessary.

In particular, in this case, a voltage of a power used may be variously generated and used, if necessary, by those skilled in the art if the sizes of standard voltages of electric vehicles that are sold on the market are variously different. For example, if charging standard voltages of electric vehicles are 800 V and 400 V, all the charging standard voltages may be accommodated by considering the ratio of the number of vehicles of the two vehicles.

The new renewable generator 100, such as sunlight, may include new renewable generators, such as solar energy generation and wind power generation. Solar energy generation is described as an example. Solar energy generation is a generation method of generating power by converting sunlight into DC electricity, and can generate power by using a solar panel to which several solar cells have been attached.

The solar panel has its output voltage determined depending on a construction of the solar cells and has a different current generated depending on the intensity of light. Power that is generated depending on the intensity of light is continuously changed. The charging system according to the present disclosure needs to supply a charging speed (requested power) requested by a charging wisher, and can supply a stable charging speed (requested power) by storing power generated by the solar energy generation in the ESS 200.

If power generated as in the solar energy generation is DC, the power may be converted and stored in accordance with a charging voltage of the ESS 200 by using a D/D. If power generated as in the wind power generation is AC, the power may be stored by using an AC/DC converter. In the example, the solar energy generation and the wind power generation have been described as examples, but the present disclosure is not limited to a corresponding generation method and various types of new renewable generation may be used.

The ESS 200 means an energy storage system, and may include several apparatuses for constructing the ESS 200, such as a battery, a battery management system (BMS), and a power management system (PMS). Apparatuses may be added or omitted if necessary.

The ESS 200 may be charged with new renewable energy, and may be charged during daytime when solar energy generation, for example, is used, but may be charged with power that is supplied by the AC/DC converting system 2000 if the ESS cannot be charged normally at night or in a dark day or in a time zone in which electric charges are cheap.

Furthermore, the output voltage of a battery of the ESS 200 may be the same as a voltage that is used in the DC power delivery system 500. If the output voltage is different from the voltage that is used in the DC power delivery system 500, the voltage may be supplied after being converted into the voltage that is used in the DC power delivery system 500 by using a D/D.

Power of the AC/DC converting system 2000 may be supplied to the DC power delivery system 500 or energy stored in the ESS 200 may be supplied to the DC power delivery system 500. For example, the battery of the ESS 200 may be charged by using power generated by new renewable energy in the daytime, and the energy stored in the ESS 200 may be supplied to the DC power delivery system 500.

In the example, if the speed at which the battery of the ESS 200 is charged by using power generated by the new renewable generator 100 such as sunlight is lower than the speed at which power is used and consumed by the DC power delivery system 500, not only energy stored in the ESS 200, but power supplied by the AC/DC converting system 2000 may be used.

Furthermore, electric charges that are charged upon charging can be reduced by charging the battery of the ESS 200 in a time zone in which electric charges are cheap as in the night and preferentially using energy stored in the ESS 200 over power supplied by the AC/DC converting system 2000 in a time zone in which electric charges are relatively expensive. Energy stored in the ESS 200 may be resold to an electricity supply company in the time zone in which electric charges are expensive.

In the embodiment, the solar energy generation has been described as an example, but the present disclosure is not limited to the power generation method and various new renewable power generation methods, such as wind power, may be used.

Detailed structures of the request power manipulation units 3000, relay connection power grids 4000, and intra-parking lot power grids 5000 of the first to fifth DC power delivery systems 510, 520, 530, 540, and 550 may be the same or may be differently constructed, if necessary.

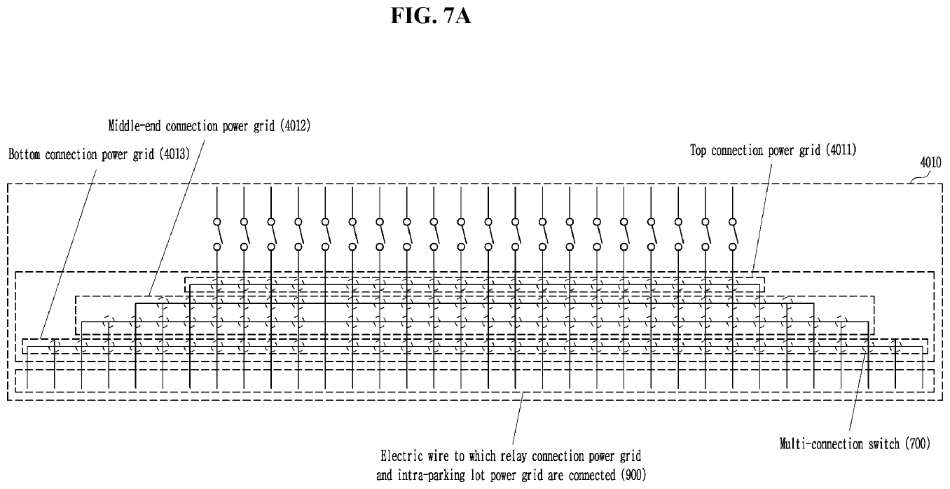

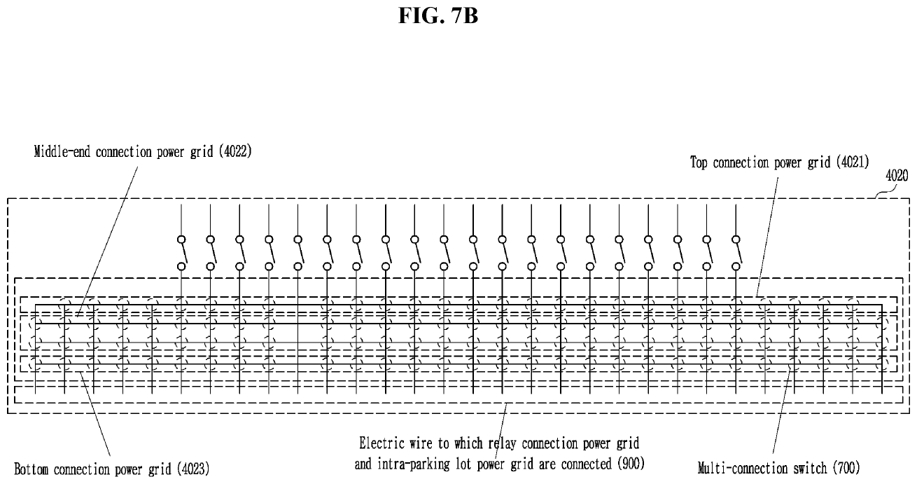

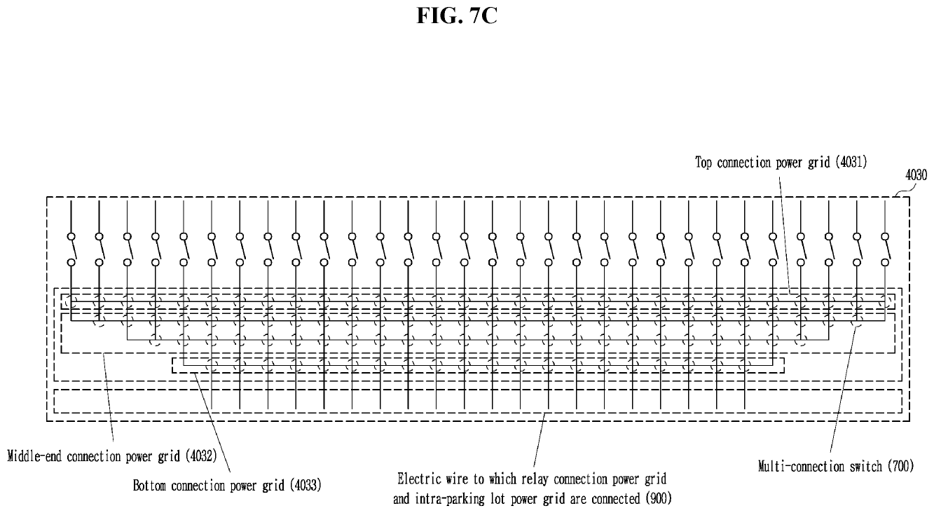

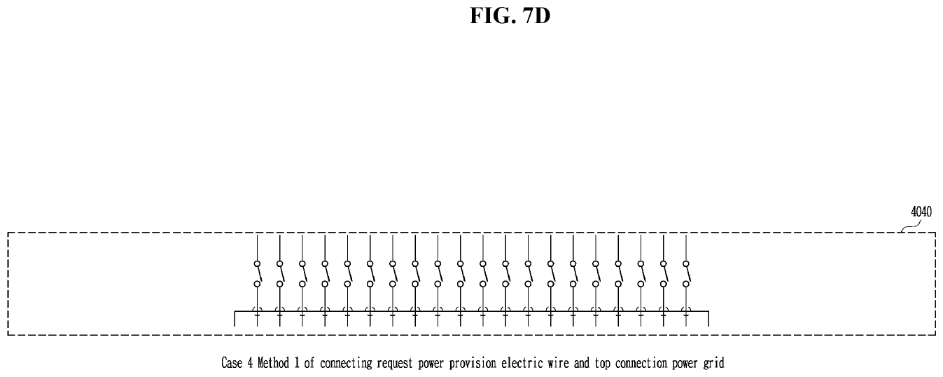

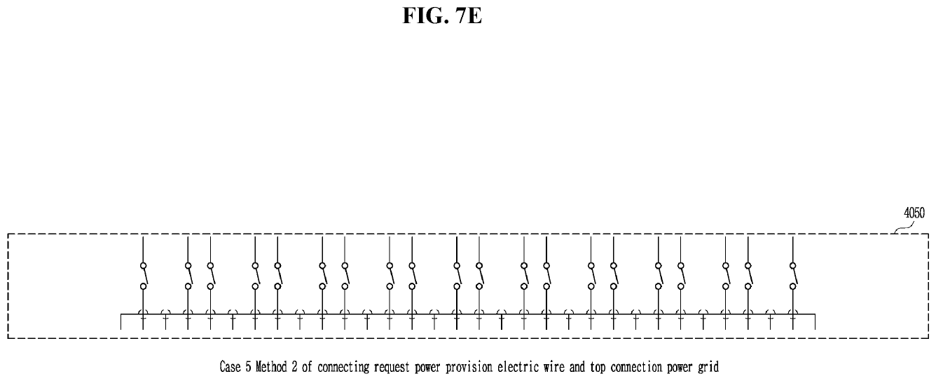

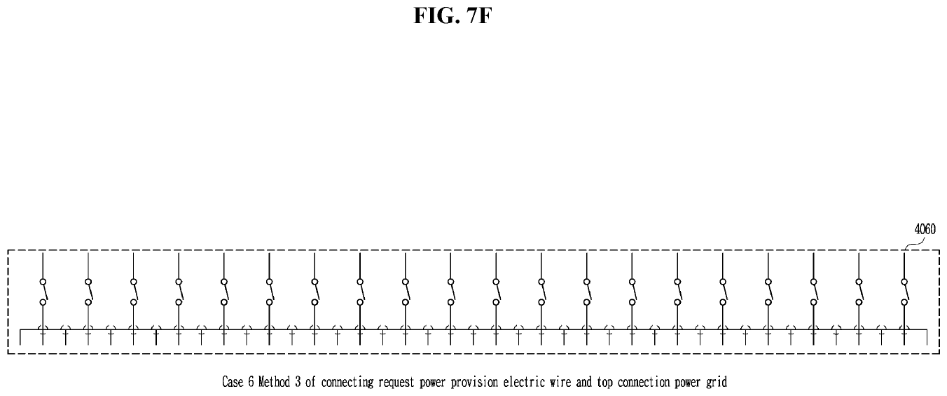

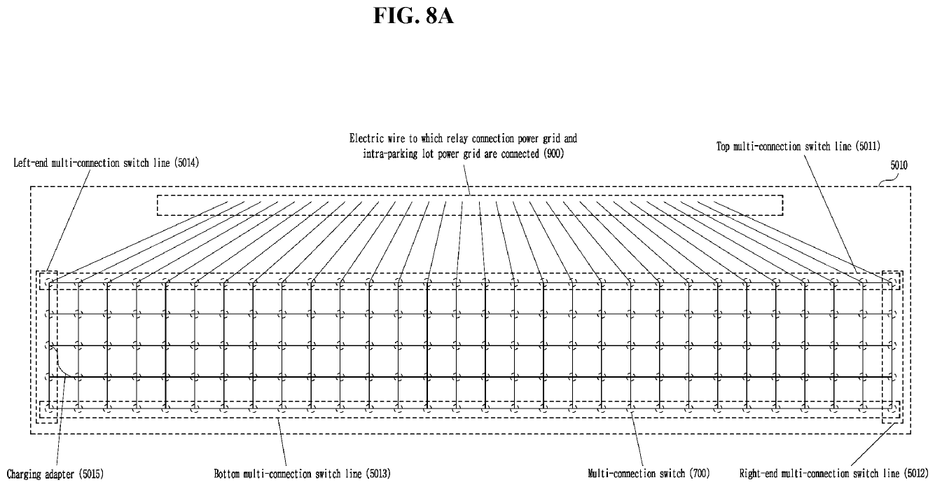

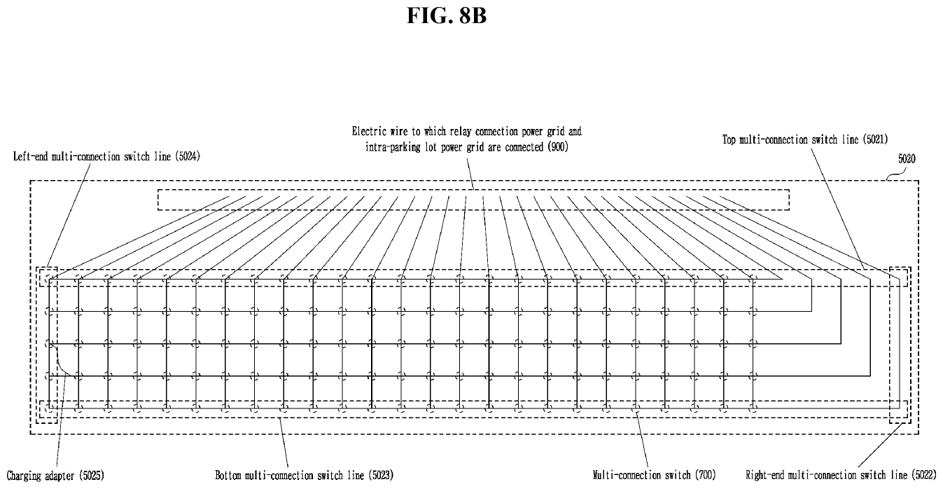

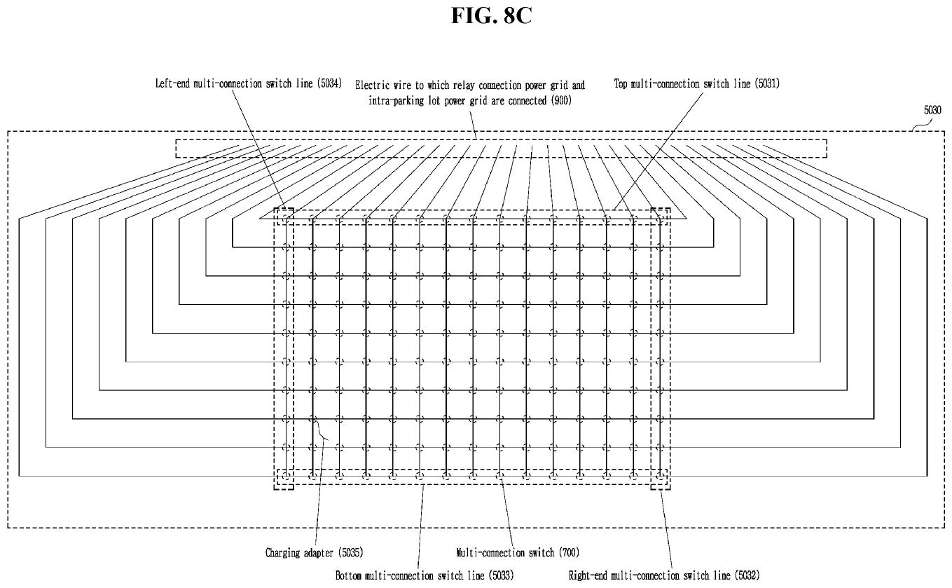

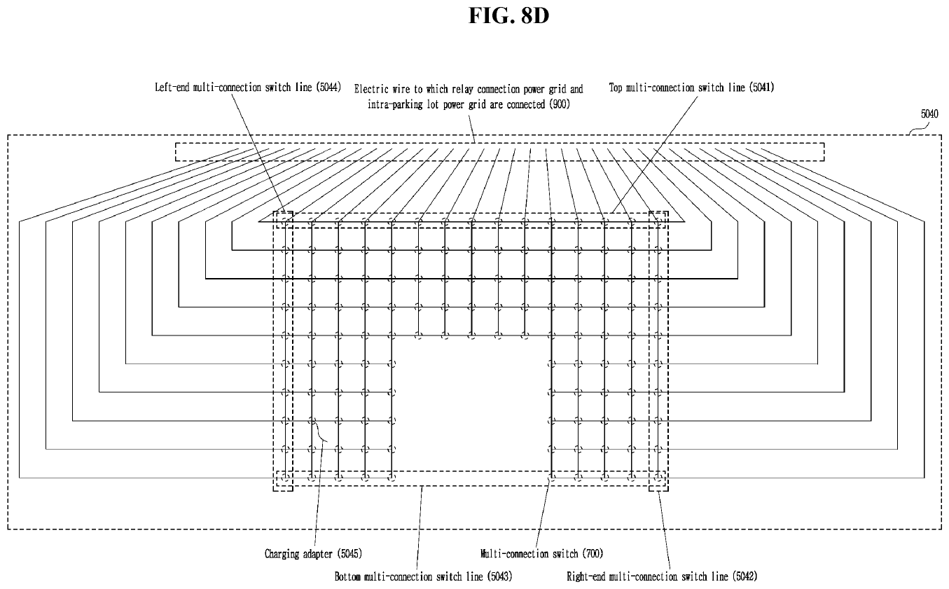

FIG. 2A is an embodiment according to the present disclosure, including the request power manipulation unit 3000 consisting of a request power manipulation unit (a) 3010 of FIG. 6A, the relay connection power grid 4000 consisting of a relay connection power grid (a) 4010 of FIG. 7A, and the intra-parking lot power grid 5000 consisting of an intra-parking lot power grid (a) 5010 of FIG. 8A.

In the embodiment, a charging speed (requested power) that is determined by a current fixed type D/D 3011 of the request power manipulation unit (a) 3010 may be selected as a charging speed (requested power) that is requested by a charging wisher. The corresponding charging speed (requested power) may be supplied to the charging adapter 5015 that is connected to the charging target vehicle 9000, by forming a path of the relay connection power grid (a) 4010 and the intra-parking lot power grid (a) 5010, which has a pyramid form.

All of the current fixed type D/Ds 3011 of the request power manipulation unit (a) 3010 may supply charging speeds (requested power) having the same size, but may supply charging speeds having different sizes. The charging speed (requested power) of each current fixed type D/D 3011 may be variously determined by considering a situation in a corresponding parking lot upon installation.

In the embodiment, when the current fixed type D/D 3011 of the request power manipulation unit (a) 3010 is selected in response to the selection of a charging speed (requested power) by a charging wisher, a path is formed between the relay connection power grid (a) 4010 and the intra-parking lot power grid 5010. When a corresponding task is completed, the charging speed (requested power) may be supplied by making ON an open circuit connection switch 3012 of the request power manipulation unit (a) 3010.

Furthermore, there is an advantage in that a charging speed (requested power) can be provided from slow charging to quick charging using DC power by variously constructing D/Ds in response to the selection of a charging wisher.

If a path is formed when electricity flows, various electrical problems, such as a counter electromotive force, may occur. However, if a charging speed (requested power) is supplied by making ON the open circuit connection switch 3012 after a path is formed as in the embodiment, there is an advantage in that such a problem can be prevented.

Furthermore, although not separately illustrated in the embodiment, as in the present disclosure, a device, such as a DC circuit breaker for blocking a fault current when a breakdown occurs while DC power is used, may be added. Devices capable of preventing an accident which may occur while DC power is used, such as a reverse current relay, an earthly world relay, and a remaining current device, may be additionally used.

Furthermore, in the embodiment, the D/Ds of the request power manipulation unit have been represented, but the D/Ds of the request power manipulation unit may include various design methods or constructions for DC/DC conversion in addition to DC/AC conversion—AC/DC conversion depending on an advantage in design or circumstances.

In the present disclosure, not electricity for charging an electric vehicle, but AC for common households may be used as electricity that makes move a multi-connection switch 700 that is used in the connection power grid 600 in order to set a path.

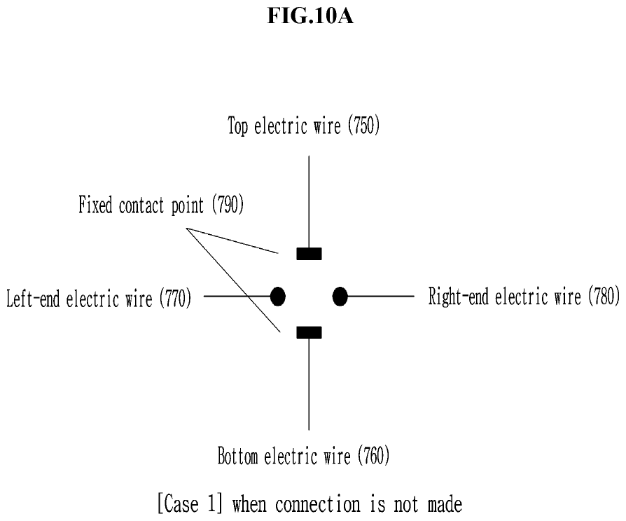

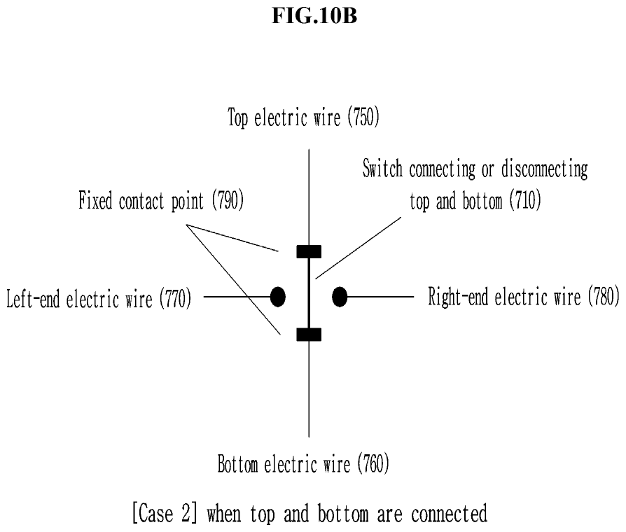

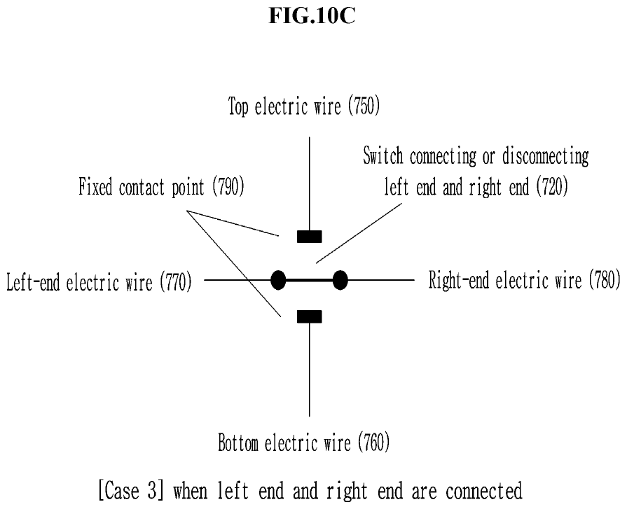

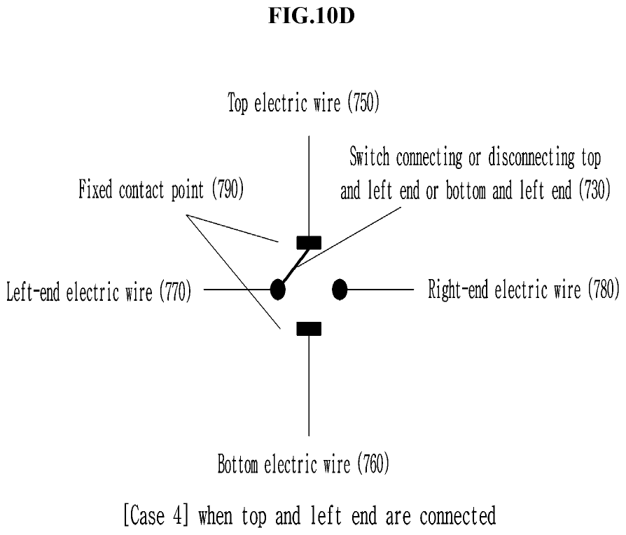

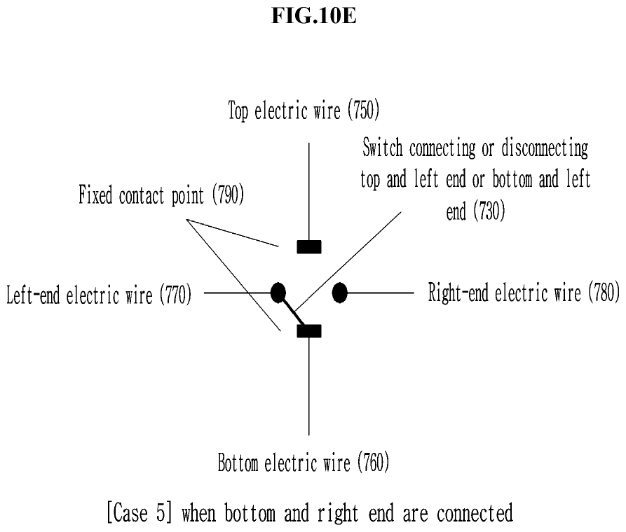

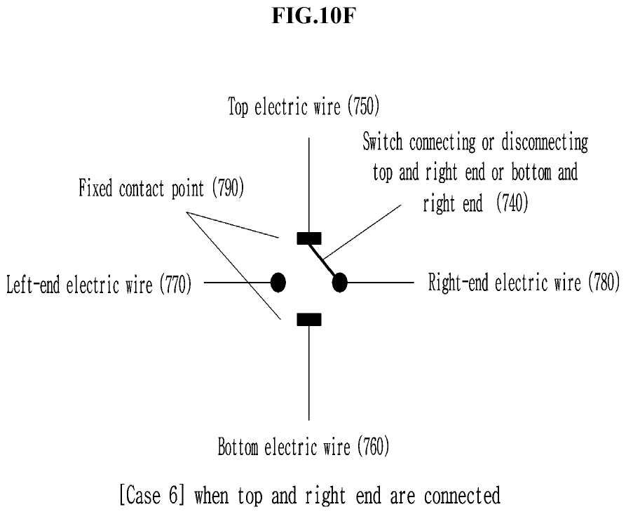

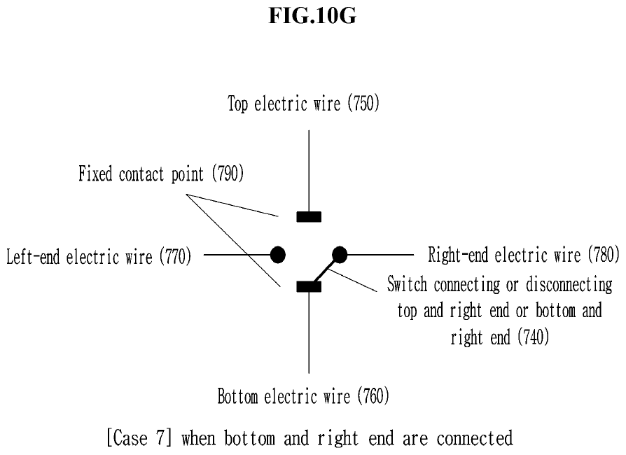

As one embodiment, a square that has the number of cases of connections in FIGS. 10A to 10G and that is continuous left and right and up and down is disclosed as a shape of a connection of the multi-connection switch 700 that is used in the present disclosure. However, this is for sufficiently securing the number of cases of connection paths of the multi-connection switches 700 so that a new path can be formed without a crosstalk with the paths of the charging target vehicles 9000 whose paths have already been formed and that are being charged, which are various and may be said to be randomly connected in principle, among chargeable adapters in many parking lots the number of which is much large in the request power manipulation unit 3000 having a small number of power supply lines.

Therefore, as an embodiment, FIGS. 10A to 10G illustrate one embodiment. If the number of cases is sufficiently secured by only a smaller number of switches according to circumstances or based on continued experiences, the number of cases may be adjusted and selected by those skilled in the art.

Alternatively, the multi-connection switches may be connected in the form of a triangle, a hexagon, etc. in which the multi-connection switches are consecutively connected in all directions or may be connected in the form of a stereoscopic connection structure. For example, the multi-connection switches may have a regular tetrahedron or a regular hexahedron. A shape of the multi-connection switch may be slightly crushed and used, if necessary. Furthermore, these shapes may be mixed and used.

An important point is whether the number of cases of connection paths of the multi-connection switch 700 can be sufficiently secured so that a new path can be formed without a crosstalk with the paths of the charging target vehicles 9000 whose paths have already been formed and that are being charged, which are various and may be said to be randomly connected in principle, among chargeable adapters in many parking lots the number of which is much large in the request power manipulation unit 3000 having a small number of power supply lines.

As another embodiment, the request power manipulation unit 3000 may be directly connected to the intra-parking lot power grid 5000 without the relay connection power grid 4000. For example, the intra-parking lot multi-connection switch 700 is installed, but the request power manipulation unit 3000 may be directly connected to the intra-parking lot power grid 5000 through multiple portions in which a charging adapter 5015, 5025, 5035, and 5045 (hereinafter 5015) is not present, if necessary. Even in this case, the reason for this is that the number of cases of a connection path for the multi-connection switches 700 can be sufficiently secured.

Furthermore, for example, when a charging wisher connects the charging adapter 5015 and sets a charging end time, the charging wisher may set electricity so that the electricity does not flow by releasing a switch connected to the charging adapter 5015 through control of the multi-connection switch 700 to which the charging adapter 5015 is connected before charging starts. The charging system according to the present disclosure may control a charging speed, an open circuit connection switch 3012, etc. so that charging is completed based on a corresponding desired time when a charging end time is set.

After the charging end time is reached or the charging is completed, although the charging adapter 5015 continues to be connected to the multi-connection switch 700 without being removed, electricity may be set to not flow until a charging wisher releases the connection of the charging adapter 5015 by disconnecting the multi-connection switch 700 to which the charging adapter 5015 has been connected.

FIG. 2B represents, as an example, a general structure from the transformer 1000 to the charging adapter 5025 at the place where the charging target vehicle 9000 is disposed according to still another embodiment of the present disclosure. The structure includes the transformer 1000, the allowed power quantity management apparatus 1100, the AC/DC converting system 2000, the new renewable generator 100 such as sunlight, the ESS 200, and the DC power delivery system 500.

In FIG. 2B, the AC/DC converting system 2000 includes first to fifth AC/DC converting systems 2010, 2020, 2030, 2040, and 2050 as in FIG. 4B. The DC power delivery system 500 has a structure in which first to fifth DC power delivery systems 510, 520, 530, 540, and 550 are connected to the first to fifth AC/DC converting systems 2010, 2020, 2030, 2040, and 2050, respectively, as in FIG. 5C.

FIG. 2B describes, as an example, the first AC/DC converting system 2010 and the first DC power delivery system 510, among the first to fifth AC/DC converting systems 2010, 2020, 2030, 2040, and 2050 and the first to fifth DC power delivery systems 510, 520, 530, 540, and 550.

All of the first to fifth AC/DC converting systems 2010, 2020, 2030, 2040, and 2050 and the first to fifth DC power delivery systems 510, 520, 530, 540, and 550 may use DC power having the same size, and may use DC power having different sizes, if necessary.

Furthermore, detailed structures of the request power manipulation units 3000, the relay connection power grids 4000, and the intra-parking lot power grids 5000 of the first to fifth DC power delivery systems 510, 520, 530, 540, and 550 may be the same, and may be different, if necessary.

FIG. 2B is an embodiment according to the present disclosure, including the request power manipulation unit 3000 consisting of a request power manipulation unit (d) 3040 of FIG. 6D, a selective connection switch system 800, the relay connection power grid 4000 consisting of a relay connection power grid (c) 4030 of FIG. 7C, and the intra-parking lot power grid 5000 consisting of an intra-parking lot power grid (b) 5020 of FIG. 8B.

In the embodiment, a charging wisher may select a charging speed (requested power) that is determined in a current fixed type D/D 3041 of the request power manipulation unit (d) 3040 or a charging speed (requested power) which may be determined through a combination with a current fixed type D/D 3042 for a parallel connection.

Both the current fixed type D/D 3041 of the request power manipulation unit (d) 3040 and a current fixed type D/D 3042 for a parallel connection may supply charging speeds (requested power) having the same size, but may supply charging speeds (requested power) having different sizes.

The selective connection switch system 800 is constructed between the request power manipulation unit (d) 3040 and the relay connection power grid (c) 4030. A socket 3045 of the request power manipulation unit (d) 3040 and a socket 3045 of the power grid 820 that is connected to a top connection power grid of the relay connection power grid of the selective connection switch system 800 are connected to a separable and movable request power provision electric wire 810.

The separable and movable request power provision electric wire 810 may be connected by using a magnet or may be connected in a plug form. A corresponding electric wire may be directly connected by a person along a formed path, or a robot, a machine, etc. may be constructed to perform a task for disconnecting, moving, and connecting the electric wire along the path.

In the embodiment, the diagram has been constructed by using the selective connection switch system 800, but this may be omitted in some cases.

A charging speed (requested power) of each of the current fixed type D/D 3041 of the request power manipulation unit (d) 3040 and the current fixed type D/D 3042 for a parallel connection may be variously determined by considering a situation in a corresponding parking lot upon installation.

A charging speed (requested power) that is supplied by the request power manipulation unit (d) 3040 is supplied to the charging adapter 5025 that is connected to the charging target vehicle 9000 through the forming of a path of the relay connection power grid (c) 4030 and the intra-parking lot power grid (b) 5020, which has an inverted pyramid form.

In the embodiment, when a charging speed (requested power) is selected through a combination of the current fixed type D/D 3041 of the request power manipulation unit (d) 3040 or the current fixed type D/D 3042 for a parallel connection in response to the selection of the charging speed (requested power) by a charging wisher, the charging speed is connected to a top connection power grid 4031 of the relay connection power grid (c) 4030 through the selective connection system 800.

Furthermore, when a path of the relay connection power grid (c) 4030 and the intra-parking lot power grid (b) 5020 is formed and a corresponding task is completed, the charging speed (requested power) is supplied by making ON an open circuit connection switch 3043 of the request power manipulation unit (d) 3040.

As described above, one of important characteristics of the present disclosure is that the transformer 1000, the allowed power quantity management apparatus 1100, the AC/DC converting system 2000, and the request power manipulation unit 3000 can be installed in a separate space at a front end quite separately from the charging adapter 5015 of a parking zone.

Furthermore, there is an important characteristic in a charging method by DC by collectively converting AC into DC in all of separate zones different from a space in which at least the charging adapter 5015 is present.

Furthermore, since the number of chargeable parking zones is much greater than a small number of simultaneously charging vehicles, a concept in which any D/D can be connected to an adapter in any parking zone without being limited to a specific parking zone is sought according to circumstances. Such an aspect may be significantly limited according to circumstances, but the present disclosure seeks such a concept in principle.

In other words, another core characteristic of the present disclosure is that a parking space includes the charging adapter 5015 the number of which is much greater than the number of simultaneously chargeable electric vehicles. Preferably, almost all of parking spaces are designed to have the charging adapter 5015 or designed to have the charging adapter 5015 in the future. For example, the number of simultaneously chargeable electric vehicles may be 60, but the number of parking spaces including the charging adapter 5015 may be 500. In such a case, an internal combustion engine vehicle or an electric vehicle can be arbitrarily parked at the parking space regardless of the internal combustion engine vehicle or the electric vehicle. The electric vehicle does not need to be moved from the parking space although the electric vehicle has been fully charged.

Furthermore, a designated parking space may be set. Although an internal combustion engine vehicle is now used or an internal combustion engine vehicle is changed into an electric vehicle in the future, the same parking space can be used without any inconvenience.

Furthermore, in an apartment, in the case of an already registered resident (if a condition is satisfied although a charging wisher is not a resident), if the resident sets that charging has only to be performed until the resident goes to work next morning after getting off work in the evening, the resident can use electricity that is cheap at night while preferentially complying with an urgent request from another charging wisher, and can charge a battery with less strain on the battery by using relatively low power.

One of the important characteristics of the present disclosure lies in that the transformer 1000, the allowed power quantity management apparatus 1100, the AC/DC converting system 2000, and a D/D can be installed in a separate space at a front end quite separately from the charging adapter 3015 of a parking zone. Accordingly, apparatuses having a space and extensibility for additional installation or extension in the future can be incorporated upon first design. The present disclosure can be handled very flexibly if the connection power grid 600 is initially installed in almost all of parking zones (the connection power grid 600 may be designed in a way to be additionally installed in the future) or although a change into an electric vehicle within an apartment, for example, is greatly increased.

FIG. 2C is a diagram illustrating a detailed construction (c) of a system in which a D/D of the request power manipulation unit 3000 is included in the AC/DC converting system 2000, the AC/DC converter 2001 and the D/D are connected in a one-to-one way and which includes the new renewable generator 100 such as sunlight, the ESS 200, a DC power delivery system (c), a request power manipulation unit (a), a relay connection power grid (a), and an intra-parking lot power grid (a) according to an embodiment of the present disclosure.

FIG. 2D is a diagram illustrating a detailed construction (d) of a system in which the request power manipulation unit 3000 is disposed near the intra-parking lot power grid 5000 that is disposed within a building, not around the AC/DC converting system 2000, according to an embodiment of the present disclosure.

The connection power grid 600 may not include the relay connection power grid 4000 between the request power manipulation unit 3000 and the intra-parking lot power grid 5000. The request power manipulation unit 3000 may be disposed around the intra-parking lot power grid 5000, but may be disposed in a separate space within a building.

Furthermore, the AC/DC converting system 2000 includes an AC/DC converter and a D/D. The D/D and a D/D of the request power manipulation unit 3000 may be connected in a one-to-one or one-to-many way. The amount of power permitted of the D/D of the AC/DC converting system 2000 may be equal to or greater than a total charging speed of the D/D of the request power manipulation unit 3000, which is connected to the D/D.

FIG. 2E is similar to the embodiment of FIG. 2D, but is a diagram illustrating a detailed construction diagram (e) of a system according to another embodiment in which not one intra-parking lot power grid, but several intra-parking lot power grids are constructed. In the embodiment, a D/D of the AC/DC converting system 2000 and a D/D of the request power manipulation unit 3000 have been described as being constructed in one block or two-block unit, but the present disclosure is not limited to only the corresponding structure.

In FIGS. 6A to 6E, a current fixed type D/D 3011, 3021, 3041, and 3052 (hereinafter 3011) or current variable type D/D 3031 and 3051 (hereinafter 3031) of a request power manipulation unit 3010, 3020, 3030, 3040, and 3050 (hereinafter 3010) may be constructed in the AC/DC converting system 2000 as in FIG. 2C according to circumstances.

When the current fixed type D/D 3011 or the current variable type D/D 3031 is constructed in the AC/DC converting system 2000, one D/D may be connected to one AC/DC converter 2001, and several D/Ds may be connected to one AC/DC converter 2001.

Most of the descriptions of the embodiments of the present disclosure have been given on the premise that the current fixed type D/D 3011 and the current variable type D/D 3031 are constructed within the request power manipulation unit 3010, but the present disclosure is not limited to only a corresponding structure. The current fixed type D/D 3011 and the current variable type D/D 3031 may be included in the AC/DC converting system 2000 depending on the design when an actual system is constructed.

All of the AC/DC converters 2001 may be constructed to have power having the same size, but may be constructed to have power having different sizes depending on the design.

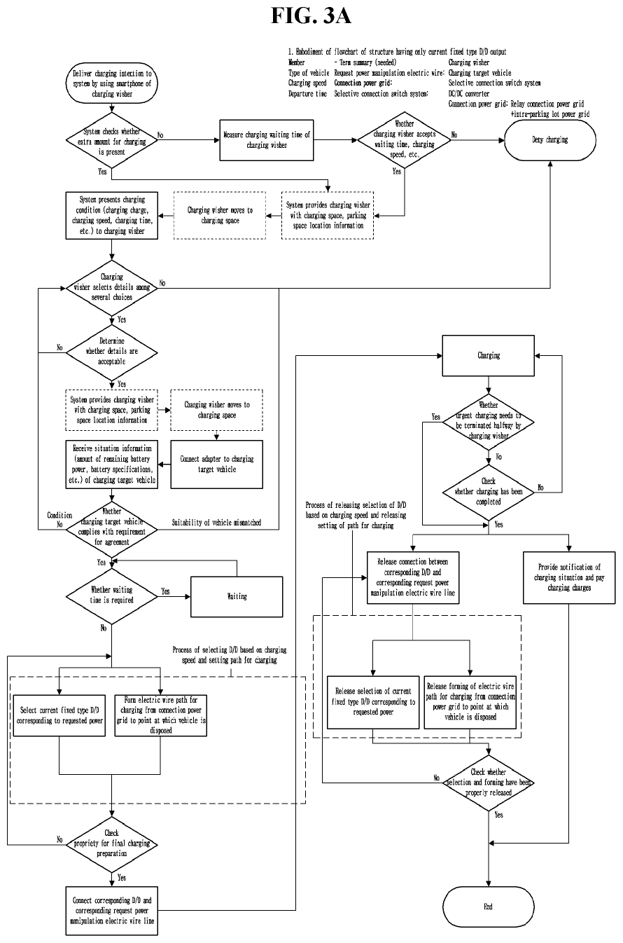

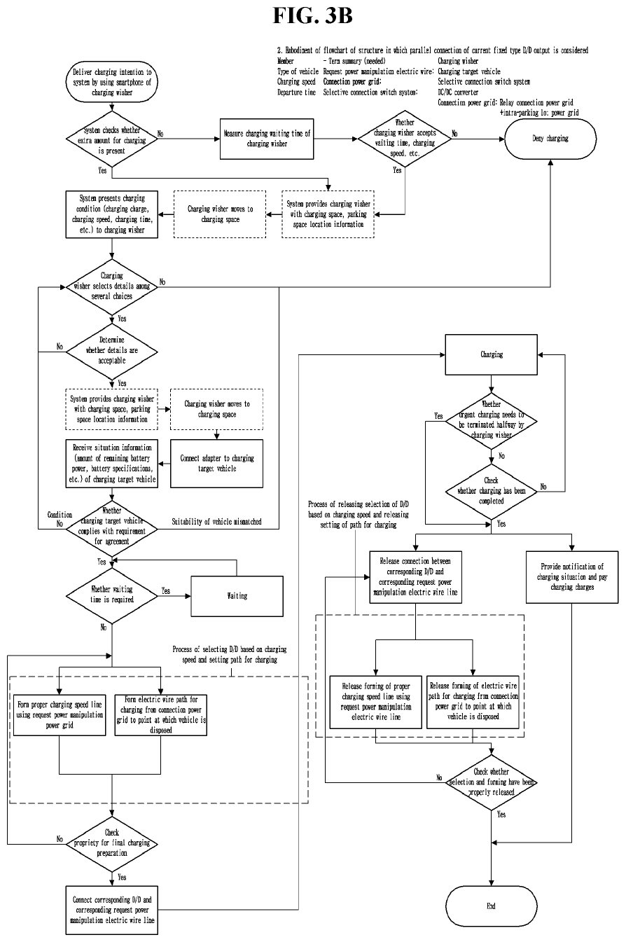

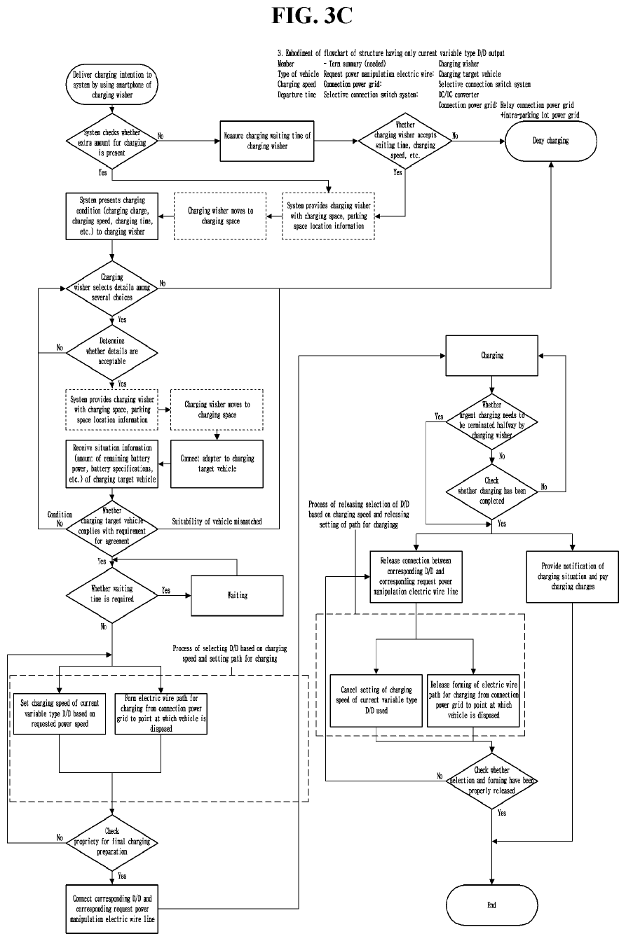

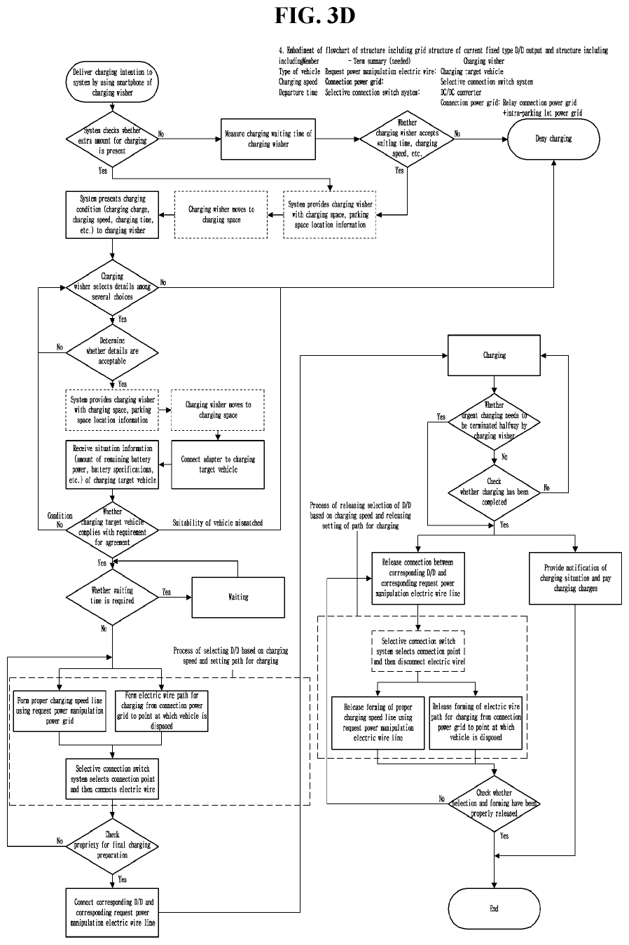

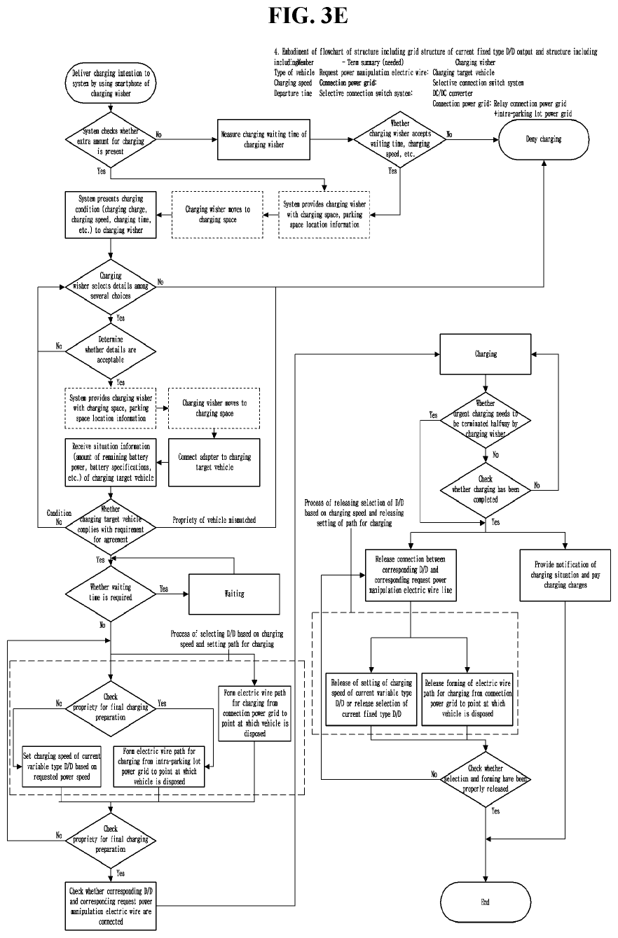

FIGS. 3A to 3E illustrate flowcharts (a) to (e) according to embodiments of the present disclosure. In most of the flowcharts, charging is performed by the same process. However, a process of selecting a D/D and setting a path for charging according to a charging speed may be different from a process of releasing the selection of a D/D and releasing the setting of the path for charging process according to the charging speed.

FIG. 3A is a diagram illustrating the flowchart (a) of the present disclosure in the case of the request power manipulation unit (a) 3010 that consists of only the current fixed type D/D 3011. FIG. 3B is a diagram illustrating of the flowchart (b) of the present disclosure in the case of a request power manipulation unit (b) 3020 in which a current fixed type D/D 3021 and a current fixed type D/D 3022 for a parallel connection are connected in parallel and which supplies more various charging speeds (requested power) through a combination of the two D/Ds.

FIG. 3C is a diagram illustrating the flowchart (c) of the present disclosure in the case of a request power manipulation unit (c) 3030 that consists of only a current variable type D/D 3031 and that changes and supplies a charging speed (requested power) within a maximum output current based on a charging speed (requested power) set by a charging wisher.

FIG. 3D is a diagram illustrating the flowchart (d) of the present disclosure in the case of a request power manipulation unit (d) 3040 that supplies a charging speed (requested power) through a parallel connection as in FIG. 3B, but can supply a charging speed (requested power) to any place of a socket 3045 of the multi-connection switch 700, which is disposed at a point at which a request power manipulation electric wires 3044 are intersected.

FIG. 3E is a diagram illustrating a flowchart (e) of the present disclosure in the case of a request power manipulation unit (e) 3050 that consists of a current variable type D/D 3051 and a current fixed type D/D 3052 and that supplies a charging speed (requested power) requested by a charging wisher through a D/D selected, among the D/Ds, based on the charging speed (requested power) or supplies the charging speed (requested power) by changing the charging speed (requested power).

In a step of delivering charging intention to the system by using a smartphone of a charging wisher, the first charging wisher delivers the charging intention, including the type of vehicle, a charging speed, a charging time, etc., to the system by using the smartphone. The smartphone has been taken as an example, but may be a portable terminal, kiosk or a computer installed in a parking lot, etc.

Furthermore, the charging intention of the charging wisher may be possible over a phone.

The charging intention of the charging wisher may be simply delivered through a password, etc. by using a portal site, a telephone, etc. based on already registered information.

Furthermore, the charging intention of the charging wisher may be delivered by using a method of specifying only a charging finishing time and entrusting a charging system to properly perform the remaining charging method. For example, in the case of an apartment parking lot, if an already registered resident has indicated out-vehicle at 8 a.m. the next morning while parking his or her vehicle at 7 p.m. last night and wanted the charging of the vehicle, a method completing, by the system of the present disclosure, proper charging until 7:30 a.m. next day at a relatively low speed that is beneficial to an electric vehicle battery by using low power charges at night may be considered.

In this case, furthermore, although the vehicle is charged at a low speed, if many urgent charging wishers appear, the system may temporarily stop the charging of a corresponding charging target vehicle 9000, may accommodate the requirement of the urgent charging wishers, and may charge the corresponding charging target vehicle 9000 by connecting the corresponding charging target vehicle 9000 to the system.

In a step of checking, by the system, whether an extra amount for charging is present, the system checks whether charging power has remained by checking a total amount of power being used. If an extra amount for charging is present, the system performs a step of providing a charging wisher with a charging space and parking space location information. If an extra amount for charging is not present, the system may measure a charging waiting time of the charging wisher.

In the step of measuring the charging waiting time of the charging wisher, the system checks charging completion times of vehicles that are now being charged, measures the time during which the charging wisher has to wait for charging, and provides the charging wisher with information, such as a waiting time and a charging speed.

In a step of determining whether the charging wisher accepts the waiting time, the charging speed, etc., when the charging wisher accepts the waiting time, the charging speed, etc., the system provides the charging wisher with a charging space and parking space location information. When the charging wisher does not accept the waiting time, the charging speed, etc., the system terminates the process by recognizing the denial of the waiting time, the charging speed, etc., as charging denial.

In the step of providing, by the system, the charging wisher with the charging space and the parking space location information, the system provides the charging wisher with the information, and may wait until a movement of the charging wisher to a charging space is completed. The step of providing, by the system, the charging wisher with the charging space and the parking space location information and the step of the charging wisher moving to the charging space may be omitted.

In the step of presenting, by the system, the charging wisher with charging conditions (charging charges, the charging speed, the charging time, etc.), the system may present charging conditions, such as charging charges, a charging speed (requested power) which may be provided, etc., every time zone in which charging is possible. The conditions are merely an example according to an embodiment of the present disclosure, and may be different depending on information necessary for charging.

A step of selecting, by the charging wisher, details among several choices is a step of the charging wisher selecting the details in detail when the conditions are presented to the charging wisher. When the charging wisher completes the selection of details, the system performs a step of finally determining whether to accept the details. If the charging wisher denies the selection, the system may terminate the process by recognizing the denial of the selection as charging denial.

The step of determining whether to accept the details is a step of determining whether to finally accept the conditions which have been selected by the charging wisher in the step of selecting, by the charging wisher, the details among the several choices. If the charging wisher accepts the details, the system performs a next step. If the charging wisher denies the details, however, the step of selecting, by the charging wisher, the details among the several choices may be performed, which is a previous step.

In the step of providing, by the system, the charging wisher with the charging space and the parking space location information, the system may provide the charging wisher with the information, and may wait until a movement of the charging wisher to a charging space is completed. This step may be omitted if the system has provided the charging wisher with the charging space and the parking space location information and has performed the step of the charging wisher moving to the charging space, prior to the step of presenting, by the system, the charging conditions (the charging charges, the charging speed, the charging time, etc.) to the charging wisher.

A step of connecting an adapter to the charging target vehicle is a step of connecting the charging adapter 5015, 5025, 5035, and 5045 (hereinafter 5015) to the charging target vehicle 9000. When the connection of the adaptor to the charging target vehicle is completed, a step of receiving charging target vehicle situation information (the amount of remaining battery power, battery specifications, etc.) is performed.

In receiving the situation information (the amount of remaining battery power, battery specifications, etc.) of the charging target vehicle, information on the amount of battery power that currently remains, information of battery specifications necessary for battery charging, vehicle information of the charging target vehicle 9000, etc. is received from the charging target vehicle 9000 connected to the charging adapter 5015.

A step of determining whether the charging target vehicle 9000 complies with requirements for an agreement is a step of determining whether information selected in the step of selecting, by the charging wisher, the details among the several choices and the charging target vehicle 9000 comply with the requirements for the agreement. The time that is taken for charging to be completed based on the amount of remaining battery power of the charging target vehicle 9000 may be additionally indicated. When the charging target vehicle 9000 complies with the requirements for the agreement, a step of determining whether a waiting time is required is performed.

However, these processes, etc. may be simply performed through the recognition of an RFID or a QR code on which information has been recorded, etc. based on already registered information.

In the step of determining whether the charging target vehicle 9000 complies with the requirements for the agreement, when the charging target vehicle 9000 does not comply with the requirements for the agreement, the step of selecting, by the charging wisher, the details among the several choices is performed. If the charging target vehicle 9000 is a vehicle which cannot be charged in the charging system according to the present disclosure, that is, the mismatch of vehicle suitability, the system denies charging and terminates the process.

In the step of determining whether the waiting time is required, waiting if waiting up to a charging start time is required and the step of determining whether the waiting time is required are repeatedly performed. When the charging start time is reached, the step of selecting the D/D based on the charging speed and the step of setting the path for charging are performed.

The process of selecting the D/D based on the charging speed and setting the path for charging is slightly different in FIGS. 3A to 3E.

In FIG. 3A, in the process of selecting the D/D based on the charging speed and setting the path for charging, a step of selecting a current fixed type D/D corresponding to requested power and a step of forming an electric wire path for charging from the connection power grid to a point at which the vehicle is disposed are simultaneously performed.

In the step of selecting the current fixed type D/D, the current fixed type D/D is selected based on a charging speed (requested power) selected by the charging wisher. In a step of forming a charging electric wire path from the connection power grid to the point at which the vehicle is disposed, a path for charging is formed by controlling the relay connection power grid 4000 and the multi-connection switch 700 of the intra-parking lot power grid 5000.

In FIG. 3B, in the process of selecting a D/D according to the charging speed and setting a path for charging, a step of forming a proper charging speed line using the request power manipulation electric wire and a step of forming a charging electric wire path from the connection power grid to the point at which the vehicle is disposed are simultaneously performed.

The step of forming a proper charging speed line using the request power manipulation electric wire is a step of selecting the current fixed type D/D 3021 based on the charging speed (requested power) selected by the charging wisher or forming the charging speed line by connecting the request power manipulation electric wires 3024 through control of the multi-connection switch 700 over the current fixed type D/D 3021 and the current fixed type D/D 3022 for a parallel connection.

In the step of forming the charging electric wire path from the connection power grid to the point at which the vehicle is disposed, as in FIG. 3A, the path for charging is formed by controlling the relay connection power grid 4000 and the multi-connection switch 700 of the intra-parking lot power grid 5000.

In FIG. 3C, in a process of selecting a D/D according to the charging speed and setting the path for charging, a step of selecting a current variable type D/D corresponding to the requested power and a step of forming a charging electric wire path from the connection power grid to the point at which the vehicle is disposed are simultaneously performed.

In the step of selecting a current variable type D/D, the charging speed (requested power) is changed within a maximum output current of the current variable type D/D based on the charging speed (requested power) selected by the charging wisher. In the step of forming the charging electric wire path from the connection power grid to the point at which the vehicle is disposed, the path for charging is formed by controlling the relay connection power grid 4000 and the multi-connection switch 700 of the intra-parking lot power grid 5000.

In FIG. 3D, in the process of selecting a D/D according to the charging speed and setting a path for charging, a step of forming a proper charging speed line using the request power manipulation electric wire and a step of forming a charging electric wire path from the connection power grid to the point at which the vehicle is disposed are simultaneously performed. If the selective connection system 800 is used, the step of connecting an electric wire is performed after the selective connection system selecting a connection point.

The step of forming a proper charging speed line using the request power manipulation electric wire is a step of selecting the current fixed type D/D 3041 based on a charging speed (requested power) selected by the charging wisher or forming the charging speed line by connecting the request power manipulation electric wires 3044 through control of the multi-connection switch 700 over the current fixed type D/D 3021 and the current fixed type D/D 3042 for a parallel connection.

In the step of forming a charging electric wire path from the connection power grid to the point at which the vehicle is disposed, as in FIG. 3A, the path for charging is formed by controlling the relay connection power grid 4000 and the multi-connection switch 700 of the intra-parking lot power grid 5000.

In the step of connecting an electric wire after the selective connection system selects the connection point, the selective connection system 900 may supply the charging speed (requested power) to any point that is disposed between the request power manipulation unit (d) 3040 and the relay connection power grid 4000 and at which the socket 3045 of the multi-connection switch 700 of the request power manipulation unit (d) 3040 has been installed.

In the selective connection system 900, the separable and movable request power provision electric wire 810 is connected between the request power manipulation unit (d) 3040 and the relay connection power grid 4000. A person may directly connect the separable and movable request power provision electric wire 810 to the socket 3045 along a formed path, or a robot, a machine, etc. may be constructed to perform a task for disconnecting, moving, and connecting the electric wire along the path.

The selective connection system 900 may be omitted. In this case, the separable and movable request power provision electric wire 810 may be connected to the sockets 3045 at a location that has been optimized to form the path based on the number of simultaneously chargeable vehicles.

In FIG. 3E, in a process of selecting a D/D according to the charging speed and setting a path for charging, a step of determining whether the requested power of the charging wisher can be supplied to the current fixed type D/D and a step of forming a charging electric wire path from the connection power grid to the point at which the vehicle is disposed are simultaneously performed.

If the requested power of the charging wisher can be supplied in the step of determining whether the requested power of the charging wisher can be supplied to the current fixed type D/D, a step of selecting the current fixed type D/D corresponding to the requested power may be performed. If the requested power of the charging wisher cannot be supplied, a step of setting a charging speed in the current variable type D/D may be performed.

In the step of selecting the current fixed type D/D, the current fixed type D/D 3052 may be selected based on the charging speed (requested power) selected by the charging wisher. In the step of setting the charging speed in the current variable type D/D, the charging speed (requested power) may be changed within a maximum output current of the current variable type D/D 3051 based on the charging speed (requested power) selected by the charging wisher

In the step of forming the charging electric wire path from the connection power grid to the point at which the vehicle is disposed, the path for charging is formed by controlling the relay connection power grid 4000 and the multi-connection switch 700 of the intra-parking lot power grid 5000.

When the process of selecting the D/D based on the charging speed and setting the path for charging in FIGS. 3A to 3E is terminated, a step of confirming the propriety of the final charging preparation may be performed.

In the step of confirming the propriety of the final charging preparation, whether a D/D that has been selected, changed, or combined in the previous step is a D/D corresponding to the charging speed (requested power) requested by the charging wisher may be checked, and whether the forming of the path for charging in the connection power grid 600 has been completed may be checked.

If any one of whether the D/D that has been selected, changed, or combined in the previous step is a D/D corresponding to the charging speed (requested power) requested by the charging wisher and whether the forming of the path for charging in the connection power grid 600 has been completed has not been completed in the step of confirming the propriety of the final charging preparation, the process of selecting the D/D based on the charging speed and setting the path for charging may be performed again. If whether the D/D that has been selected, changed, or combined in the previous step is a D/D corresponding to the charging speed (requested power) requested by the charging wisher and whether the forming of the path for charging in the connection power grid 600 has been completed has been completed, a step of connecting a corresponding D/D and a corresponding request power manipulation electric wire line is performed.

In the step of connecting the corresponding request power manipulation electric wire line, the open circuit connection switches 3012, 3023, 3032, 3043, and 3053 of the request power manipulation units (a) to (e) 3010, 3020, 3030, 3040, and 3050 are made ON and connected to the request power provision electric wires 3013, 3033, and 3054 or the request power manipulation electric wires 3024 and 3044, and the charging speed (requested power) is supplied.

In the charging step, the charging is performed. In a step of determining whether the urgent termination of charging is required halfway by the charging wisher, etc., whether the charging needs to be terminated is checked. If the charging needs to be terminated, steps subsequent to the step of checking whether the charging has been completed are performed. If the charging does not need to be terminated, a step of checking whether the charging has been completed is performed.

In the step of checking whether the charging has been completed, if the charging has not been completed, the process may proceed to the charging step. If the charging has been completed, a step of releasing the connection of the corresponding D/D and the corresponding request power manipulation electric wire line and a step of providing notification of a charging situation and paying charging charges may be performed.

In the step of releasing the connection of the corresponding D/D and the corresponding request power manipulation electric wire line, the supply of the charging speed (requested power) may be blocked by making OFF the open circuit connection switches 3012, 3023, 3032, 3043, and 3053 of the request power manipulation units (a) to (e) 3010, 3020, 3030, 3040, and 3050 and releasing the connection of the request power provision electric wires 3013, 3033, and 3054 or the request power manipulation electric wires 3024 and 3044.

When the step of releasing the connection of the corresponding D/D and the corresponding request power manipulation electric wire line is completed, a step of releasing the selection of the D/D according to the charging speed and releasing the setting of the path for charging process may be performed.

In FIG. 3A, in the process of releasing the selection of the D/D according to the charging speed and releasing the setting of the path for charging, a step of releasing the selection of a current fixed type D/D corresponding to the requested power and a step of releasing the forming of the charging electric wire path from the connection power grid to the point at which the vehicle is disposed may be simultaneously performed.

The step of releasing the selection of the current fixed type D/D corresponding to the requested power is a step of releasing the selection of the current fixed type D/D 3011 that is used for corresponding charging. The step of releasing the forming of the charging electric wire path from the connection power grid to the point at which the vehicle is disposed is a step of releasing the path that has been formed for the charging by controlling the relay connection power grid 4000 and the multi-connection switch 700 of the intra-parking lot power grid 5000.

In FIG. 3B, in the step of releasing the selection of the D/D according to the charging speed and releasing the setting of the path for the charging, a step of releasing the forming of the proper charging speed line using the request power manipulation electric wire and a step of releasing the forming of the charging electric wire path from the connection power grid to the point at which the vehicle is disposed may be simultaneously performed.

The step of releasing the forming of a proper charging speed line using the request power manipulation electric wire is a step of releasing the selection of the current fixed type D/D 3021 that has been used for corresponding charging or the current fixed type D/D 3022 for a parallel connection and releasing the forming of the charging speed line of the request power manipulation electric wires 3024 through control of the multi-connection switch 700.

The step of releasing the forming of the charging electric wire path from the connection power grid to the point at which the vehicle is disposed is a of releasing the path that has been formed for the charging by controlling the relay connection power grid 4000 and the multi-connection switch 700 of the intra-parking lot power grid 5000.

In FIG. 3C, in the step of releasing the selection of the D/D according to the charging speed and releasing the setting of the path for the charging, a step of cancelling the setting of the charging speed of a current variable type D/D that has been used and a step of releasing the forming of the charging electric wire path from the connection power grid to the point at which the vehicle is disposed may be simultaneously performed.

In the step of cancelling the setting of the charging speed of the current variable type D/D that has been used, the setting of the charging speed of the current variable type D/D 3031 that has been used for corresponding charging is released. The step of releasing the forming of the charging electric wire path from the connection power grid to the point at which the vehicle is disposed is a step of releasing the path that has been formed for the charging by controlling the relay connection power grid 4000 and the multi-connection switch 700 of the intra-parking lot power grid 5000.

In FIG. 3D, in the step of releasing the selection of the D/D according to the charging speed and releasing the setting of the path for the charging, if the selective connection system 800 is used, after the selective connection system selects a connection point, a step of disconnecting the electric wire is performed. Thereafter, a step of releasing the forming of the proper charging speed line using the request power manipulation electric wire and a step of releasing the forming of the charging electric wire path from the connection power grid to the point at which the vehicle is disposed may be simultaneously performed.

In the step of disconnecting the electric wire after the selective connection system selects the connection point, when the selective connection system 900 forms a path, a person may directly separate the separable and movable request power provision electric wire 810, which is connected between the request power manipulation unit (d) 3040 and the relay connection power grid 4000, from the socket 3045 or a robot or a machine, etc. may be constructed and may perform a task for disconnecting electric wires along the path.

The selective connection system 900 may be omitted. In this case, the separable and movable request power provision electric wire 810 and which has been connected to the sockets 3045 at the location that has been optimized to form a path based on the number of simultaneously chargeable vehicles is not separated.

The step of releasing the forming of the proper charging speed line using the request power manipulation electric wire is a step of releasing the selection of the current fixed type D/D 3041 that has been used for corresponding charging or the current fixed type D/D 3042 for a parallel connection and releasing the forming of the charging speed line of the request power manipulation electric wires 3044 through control of the multi-connection switch 700.

The step of releasing the forming of the charging electric wire path from the connection power grid to the point at which the vehicle is disposed is a step of releasing the path that has been formed for the charging by controlling the relay connection power grid 4000 and the multi-connection switch 700 of the intra-parking lot power grid 5000.

In FIG. 3E, in the step of releasing the selection of the D/D according to the charging speed and releasing the setting of the path for the charging, a step of releasing the setting of the charging speed of the current variable type D/D or releasing the selection of the current fixed type D/D and the step of forming the charging electric wire path from the connection power grid to the point at which the vehicle is disposed may be simultaneously performed.

The step of releasing the setting of the charging speed of the current variable type D/D or releasing the selection of the current fixed type D/D is a step of releasing the setting of the charging speed of the current variable type D/D 3051 that has been used for corresponding charging or releasing the selection of the current fixed type D/D 3052 that has been used for corresponding charging.

The step of releasing the forming of the charging electric wire path from the connection power grid to the point at which the vehicle is disposed is a step of releasing the path that has been formed for the charging by controlling the relay connection power grid 4000 and the multi-connection switch 700 of the intra-parking lot power grid 5000.

When the process of releasing the selection of the D/D based on the charging speed and releasing the setting of the path for charging is terminated, a step of checking whether the selection of the D/D based on the charging speed and the setting of the path for charging have been properly released is performed. If the selection of the D/D based on the charging speed and the setting of the path for charging have been properly released, the process is terminated. If the selection of the D/D based on the charging speed and the setting of the path for charging have not been properly released, however, the process is performed again from the step of releasing the connection of a corresponding D/D and a corresponding request power manipulation electric wire line.

In steps, such as the notification of the charging situation and the payment of charging charges, information indicating that charging has been completed or terminated and information, such as the amount of power used for charging, are delivered to the control unit 400. The payment of charging charges received from the control unit, etc. is performed. The execution process is merely an example according to an embodiment of the present disclosure, and detailed contents may be different depending on a process that is performed after charging is completed.

FIG. 4A illustrates an example of a case in which one AC/DC converting system 2000 is constructed according to an embodiment of the present disclosure. FIG. 4B illustrates an example of a case in which the AC/DC converting system 2000 includes five first to fifth AC/DC converting systems 2010, 2020, 2030, 2040, and 2050. In the above example, the five first to fifth AC/DC converting systems 2010, 2020, 2030, 2040, and 2050 have been constructed, but AC/DC converting systems smaller or greater than 5 may be constructed according to circumstances.

The AC/DC converting system plays a role to primarily convert AC power received from the transformer into DC power to be supplied to the DC power delivery system. Power received via the transformer from the outside is unstable. If the received power is used without any change, a problem, such as a malfunction or deterioration, may occur due to the unstable power. However, with the development of the technology, the use of multiple AC/DC converting systems 2000 is not excluded by omitting the DC/DC converting system.

The AC power is primarily converted into the DC power through the AC/DC converting system 2000. The converted DC power is stabilized through a DC/DC conversion by the request power manipulation unit 3000, and is used when the charging target vehicle 9000 is charged.

If the D/D of the request power manipulation unit 3000 is constructed within the AC/DC converting system 2000, the D/D of the request power manipulation unit may be omitted.

In FIG. 4B, all of the first to fifth AC/DC converting systems 2010, 2020, 2030, 2040, and 2050 may use DC power having the same size or may generate and use DC power having different sizes, if necessary.

For example, the first AC/DC converting system 2010 may convert AC power into DC 400 V and supply the converted DC 400 V to the first DC power delivery system 510. Each of the second and third AC/DC converting systems 2020 and 2030 may convert AC power into DC 800 V and supply the converted DC 800 V to each of the second and third DC power delivery systems 520 and 530. Each of the fourth and fifth AC/DC converting systems 2040 and 2050 may convert AC power into DC 1000 V and supply the converted DC 1000 V to each of the fourth and fifth DC power delivery systems 540 and 550.

DC power of the first to fifth AC/DC converting systems 2010, 2020, 2030, 2040, and 2050 may be selected by considering a battery charging voltage of a charging target vehicle which is sold, in addition to 400 V, 800 V, and 1000 V that have been described in the above example.

FIG. 5A illustrates an example of a case in which one DC power delivery system 500 is constructed according to an embodiment of the present disclosure. FIG. 5B illustrates an example of a case in which the DC power delivery system 500 has five first to fifth DC power delivery systems 510, 520, 530, 540, and 550 constructed in one AC/DC converting system 2000. In the above example, the five first to fifth DC power delivery systems 510, 520, 530, 540, and 550 have been constructed, but DC power delivery systems smaller or greater than 5 may be constructed according to circumstances.

FIG. 5C illustrates a case in which the DC power delivery system 500 has first to fifth DC power delivery systems 510, 520, 530, 540, and 550 connected to first to fifth AC/DC converting systems 2010, 2020, 2030, 2040, and 2050, respectively, according to an embodiment of the present disclosure. In the above example, the five first to fifth DC power delivery systems 510, 520, 530, 540, and 550 and the five first to fifth AC/DC converting systems 2010, 2020, 2030, 2040, and 2050 have been constructed and connected to each other, respectively, but DC power delivery systems and AC/DC converting systems each of which is smaller or greater than 5 may be constructed according to circumstances.

FIG. 5D illustrates an example of a case in which first to fifth DC power delivery systems 510, 520, 530, 540, and 550 can exchange power. In the above example, the five DC power delivery systems have been constructed, but DC power delivery systems smaller or greater than 5 may be constructed according to circumstances.

The DC power delivery system 500 includes the request power manipulation unit 3000, the relay connection power grid 4000, and the intra-parking lot power grid 5000, and may include the selective connection switch system 800 according to circumstances.

FIG. 6A illustrates the request power manipulation unit (a) 3010. The request power manipulation unit 3000 includes a current fixed type D/D 3011, an open circuit connection switch 3012, and a request power provision electric wire 3013.

In the request power manipulation unit (a) 3010, a charging wisher may select only a charging speed (requested power) which may be provided by the current fixed type D/D 3011. The number of current fixed type D/Ds 3011 may be different depending on the number of simultaneously chargeable vehicles in the charging system according to the present disclosure. All of the sizes of charging speeds (requested power) of the current fixed type D/Ds 3011 may be the same, but may be differently constructed.

When the current fixed type D/D 3011 corresponding to the charging speed (requested power) of a charging wisher is selected in the request power manipulation unit (a) 3010, a proper path may be formed from the relay connection power grid 4000 and the intra-parking lot power grid 5000 to a location of the charging target vehicle 9000. When the forming of the path is completed, the charging speed (requested power) may be supplied by making ON the open circuit connection switch 3012 of the request power manipulation unit (a) 3010.

Furthermore, there is an advantage in that a charging speed (requested power) can be provided from slow charging to quick charging using DC power by variously constructing D/Ds in response to the selection of a charging wisher.

If a path is formed when electricity flows, various electrical problems, such as a counter electromotive force, may occur. However, if a charging speed (requested power) is supplied by making ON the open circuit connection switch 3012 after a path is formed as in the embodiment, there is an advantage in that such a problem can be prevented.

However, an apparatus that plays the same role as the open circuit connection switch 3012 of the present disclosure can be used in any one portion of the relay connection power grid through supplementation into various apparatuses, etc., and may be recognized as an embodiment in which the apparatus can be set even in the present disclosure.

Furthermore, although not separately illustrated in the embodiment, as in the present disclosure, a device, such as a DC circuit breaker for blocking a fault current when a breakdown occurs while DC power is used, may be added. Devices capable of preventing an accident which may occur while DC power is used, such as a reverse current relay, an earthly world relay, and a remaining current device, may be additionally used.

Furthermore, in the embodiment, the D/Ds of the request power manipulation unit have been represented, but the D/Ds of the request power manipulation unit may include various design methods or constructions for DC/DC conversion in addition to DC/AC conversion—AC/DC conversion depending on an advantage in design or circumstances.

Most of the descriptions of the embodiments of the present disclosure have been given on the premise that the current fixed type D/Ds 3011, 3021, 3041, and 3052 and the current variable type D/Ds 3031 and 3051 have been described as being constructed within the request power manipulation units 3010, 3020, 3030, 3040, and 3050. However, the present disclosure is not limited to the corresponding structures, and the current fixed type D/Ds 3011, 3021, 3041, and 3052 and the current variable type D/Ds 3031 and 3051 may be included in the AC/DC converting system 2000 depending on the design when an actual system is constructed.

For example, if a total amount of electricity permitted of the AC/DC converting system 2000 is 2,500 kW, assuming that the number of simultaneously chargeable electric vehicles is 60, and a total of 65 D/Ds including ten 100 kW class D/Ds, twenty 50 kW class D/Ds, and twenty 40 kW class D/Ds for quick charging, and fifteen 10 kW class D/Ds for slow charging including extra D/Ds are constructed, power when five 100 kW class D/Ds, twenty 50 kW class D/Ds, twenty 40 kW D/Ds, and fifteen 10 kW class D/Ds are used is 2,450 kW. Sixty electric vehicles can be charged by using sixty D/Ds.

As another embodiment, power when ten 100 kW class D/Ds, twenty 50 kW class D/Ds, ten 40 kW D/Ds, and ten 10 kW class D/Ds are used is 2,500 kW. The number of simultaneously chargeable electric vehicles is sixty, but only fifty electric vehicles can be charged because the amount of electricity permitted cannot exceed 2,500 kW.

Although the number of D/Ds greater than the number of simultaneously chargeable electric vehicles is constructed as in the embodiment, the number of D/Ds may be equal to or smaller than the number of simultaneously chargeable electric vehicles depending on the amount of power that is used in a system. The embodiment is an example of the number of simultaneously chargeable electric vehicles and the number of DC/DCs, and the present disclosure is not limited to a charging speed or the number of D/Ds mentioned in the embodiment. Furthermore, a distinction between quick charging and slow charging may be different depending on criteria in each country or an electric vehicle to be charged.

FIG. 6B illustrates the request power manipulation unit (b) 3020. The request power manipulation unit 3000 may be constructed to include the current fixed type D/D 3021, the current fixed type D/D 3022 for a parallel connection, the open circuit connection switch 3023, the request power manipulation electric wire 3024, the request power provision electric wire 3025, and the multi-connection switch 700.

In the request power manipulation unit (b) 3020 in FIG. 6B, in order to supplement the disadvantage in that only a charging speed (requested power) which may be provided by the current fixed type D/D 3011 of FIG. 6A can be supplied, the current fixed type D/D 3022 for a parallel connection may be connected to the current fixed type D/D 3021 in parallel, and more various charging speeds (requested power) can be supplied through a combination of the two D/Ds.

Through control of the multi-connection switch 700, a charging speed (requested power) that is supplied by the current fixed type D/D 3022 for a parallel connection may be added to a charging speed (requested power) of the current fixed type D/D 3021 from the request power manipulation electric wire 3024, and the added charging speed may be supplied to the request power provision electric wire 3025.

The current fixed type D/D 3021 and the current fixed type D/D 3022 for a parallel connection may be constructed to supply charging speeds (requested power) having various sizes. There is an advantage in that a charging speed (requested power) that is desired by a charging wisher can be supplied as much as possible through a combination of charging speeds (requested power) that are variously constructed as described above.

The number of current fixed type D/Ds 3021 and the number of current fixed type D/Ds 3022 for a parallel connection may be different depending on the number of vehicles which can be simultaneously charged in a charging system according to the present disclosure.

In a charging process of FIG. 6B, the current fixed type D/D 3021 of the request power manipulation unit (b) 3020 may be selected based on the charging speed (requested power) of a charging wisher, or a charging speed (requested power) requested by a charging wisher may be selected through a combination of the current fixed type D/D 3021 and the current fixed type D/D 3022 for a parallel connection.

Next, an optimal path may be formed from the relay connection power grid 4000 and the intra-parking lot power grid 5000 to a location of the charging target vehicle 9000. When the forming of the path is completed, the charging speed (requested power) may be supplied by making ON the open circuit connection switch 3023 of the request power manipulation unit (b) 3020.

FIG. 6C illustrates the request power manipulation unit (c) 3030. The request power manipulation unit 3000 may be constructed to include the current variable type D/D 3031, the open circuit connection switch 3032, and the request power provision electric wire 3033.

In the request power manipulation unit (c) 3030, a charging wisher may select a charging speed (requested power) within a maximum output current of the current variable type D/D 3031. The charging speed (requested power) of the charging wisher may be supplied by adjusting the output current of the current variable type D/D 3031.

The number of current variable type D/Ds 3031 may be different depending on the number of simultaneously chargeable vehicles in the charging system according to the present disclosure. There is an advantage in that all of charging speeds (requested power) requested by charging wishers can be satisfied.

In the request power manipulation unit (c) 3030, the output current of the current variable type D/D 3031 is changed based on the charging speed (requested power) of a charging wisher. An optimal path may be formed from the relay connection power grid 4000 and the intra-parking lot power grid 5000 to a location of the charging target vehicle 9000. When the forming of the path is completed, the charging speed (requested power) may be supplied by making ON the open circuit connection switch 3032 of the request power manipulation unit (c) 3030.

FIG. 6D illustrates the request power manipulation unit (d) 3040. The request power manipulation unit 3000 may be constructed to include the current fixed type D/D 3041, the current fixed type D/D 3042 for a parallel connection, the open circuit connection switch 3043, the request power manipulation electric wire 3044, the socket 3045, the multi-connection switch 700, and the separable and movable request power provision electric wire 810.

As in the requested power manipulation unit (b) 3020 of FIG. 6D, a charging speed (requested power) which may be supplied by the current fixed type D/D 3041 may be supplied, but various charging speeds (requested power) may be supplied through a combination of the current fixed type D/D 3041 and the current fixed type D/D 3042 for a parallel connection based on the charging speed (requested power) of a charging wisher.

A difference between the request power manipulation unit (d) 3040 of FIG. 6D and the request power manipulation unit (b) 3020 of FIG. 6B is that the request power manipulation unit (d) 3040 may supply a charging speed (requested power) to any place of the socket 3045 of the multi-connection switch 700, which is disposed at a point at which the request power manipulation electric wires 3044 is intersected, by connecting the separable and movable request power provision electric wire 810.

As described with reference to FIG. 2B, the separable and movable request power provision electric wire 810 may be connected between the socket 3045 of the request power manipulation unit (d) 3040 and the socket 3045 of the power grid 810, which is connected to the top connection power grid of the relay connection power grid of the selective connection switch system 800, in the selective connection switch system 800.

The separable and movable request power provision electric wire 810 may be connected by using a magnet or may be connected in a plug form. A corresponding electric wire may be directly connected by a person along a formed path, or a robot, a machine, etc. may be constructed to perform a task for disconnecting, moving, and connecting the electric wire along the path.

The number of separable and movable request power provision electric wires 810 may be different depending on the number of simultaneously chargeable vehicles or greater than the number of simultaneously chargeable vehicles, when the charging system according to the present disclosure is installed.

In the embodiment of FIG. 2B, the diagram has been constructed by using the selective connection switch system 800. However, the selective connection switch system 800 may be omitted according to circumstances. If the selective connection switch system 800 is omitted, the separable and movable request power provision electric wire 810 may be connected to the sockets 3045 of the request power manipulation unit (d) 3040 at a location that has been optimized to form a path based on the number of simultaneously chargeable vehicles.

Next, since the selective connection switch system 800 is omitted, another end portion of the separable and movable request power provision electric wire 810 may be fixedly connected to the relay connection power grid 4000.

The charging speed (requested power) of each of the current fixed type D/D 3041 of the request power manipulation unit (d) 3040 and the current fixed type D/D 3042 for a parallel connection and the number thereof may be variously determined by considering a situation in a corresponding parking lot upon installation. The sizes of charging speeds (requested power) of all of the current fixed type D/Ds 3042 may be the same, but may be differently constructed.

In a charging process of FIG. 6D, the current fixed type D/D 3041 of the request power manipulation unit (d) 3040 may be selected based on the charging speed (requested power) of a charging wisher, or a charging speed (requested power) requested by a charging wisher may be selected through a combination of the current fixed type D/D 3021 and the current fixed type D/D 3042 for a parallel connection.

Next, the current fixed type D/D 3041 of the request power manipulation unit (d) 3040 may be connected to the relay connection power grid 4000 by using the selective connection switch system 800, or may be connected to the relay connection power grid 4000 without the selective connection switch system 800.

Next, an optimal path is formed from the relay connection power grid 4000 and the intra-parking lot power grid 5000 to a location of the charging target vehicle 9000. When the forming of the path is completed, the charging speed (requested power) is supplied by making ON the open circuit connection switch 3043 of the request power manipulation unit (d) 3040.

FIG. 6E illustrates the request power manipulation unit (e) 3050. The request power manipulation unit 3000 may be constructed to include the current variable type D/D 3051, the current fixed type D/D 3052, the open circuit connection switch 3012, and the request power provision electric wire 3013.

The request power manipulation unit (e) 3050 may select the current fixed type D/D 3052 based on the charging speed (requested power) of a charging wisher and supply the charging speed (requested power) or may supply the charging speed (requested power) of the charging wisher by adjusting the output current of the current variable type D/D 3051.

The request power manipulation unit (e) 3050 may be constructed to satisfy a charging speed (requested power) that is requested by a charging wisher at a relatively low cost by using both the current fixed type D/D 3011 of FIG. 6A, which is cheap, and the current variable type D/D 3031 of FIG. 6C, which has an advantage in that all pieces of power requested by a charging wisher can be satisfied.

The numbers of current variable type D/Ds 3051 and the numbers of current fixed type D/Ds 3052 may be different depending on the number of simultaneously chargeable vehicles in the charging system according to the present disclosure. The sizes of charging speeds (requested power) of all of the current fixed type D/Ds 3052 may be the same, but may be differently constructed.

In a charging process of FIG. 6E, in the request power manipulation unit (e) 3050, the current fixed type D/D 3052 corresponding to the charging speed (requested power) of a charging wisher may be selected, or the output current of the current variable type D/D 3051 may be changed.

Next, an optimal path may be formed from the relay connection power grid 4000 and the intra-parking lot power grid 5000 to a location of the charging target vehicle 9000. When the forming of the path is completed, the charging speed (requested power) may be supplied by making ON the open circuit connection switch 3053 of the request power manipulation unit (e) 3050.

FIG. 7A is a diagram of the relay connection power grid (a) 4010, illustrating an example of a case in which the relay connection power grid 4000 is constructed in a pyramid form (a structure in which the number of power grids is increased).

The relay connection power grid (a) 4010 may be constructed to include a top connection power grid 4011, a middle-end connection power grid 4012, a bottom connection power grid 4013, the multi-connection switch 700, and an electric wire 900 to which the relay connection power grid and the intra-parking lot power grid are connected.

The relay connection power grid 4000 may be disposed between the request power provision electric wire 3013, 3025, 3033, and 3054 (hereinafter 3013) that supplies a charging speed (requested power) set in the request power manipulation unit 3000 and the intra-parking lot power grid 5000, and may be used to form a path so that the charging speed (requested power) can be supplied up to the intra-parking lot power grid 5000 along a proper path.

The proper path for supplying the charging speed (requested power) up to the intra-parking lot power grid 5000 is formed through control of the multi-connection switch 700 of the relay connection power grid 4000. The charging speed (requested power) is supplied through the electric wire 900 to which the relay connection power grid and the intra-parking lot power grid are connected.

Since the number of request power provision electric wires 3013 and the number of electric wires of the intra-parking lot power grid 5000 may be different from each other, the number of electric wires of the relay connection power grid 4000 may be different according to circumstances. The relay connection power grid (a) 4010 is constructed in a pyramid form, and may be used when the number of request power provision electric wires 3013 is smaller than the number of electric wires of the intra-parking lot power grid 5000.

FIG. 7B is a diagram of the relay connection power grid (b) 4020, illustrating an example of a case in which the relay connection power grid 4000 is constructed in a grid form. The relay connection power grid (b) 4020 has an advantage in that it can form various paths compared to the relay connection power grid (a) 4010 of FIG. 7A.

The relay connection power grid (b) 4020 may include a top connection power grid 4021, a middle-end connection power grid 4022, a bottom connection power grid 4023, the multi-connection switch 700, and the electric wire 900 to which the relay connection power grid and the intra-parking lot power grid are connected.

FIG. 7C is a diagram of the relay connection power grid (c) 4030, illustrating an example of a case in which the relay connection power grid 4000 is constructed in an inverted pyramid form (a structure in which the number of power grids is reduced). The relay connection power grid (c) 4030 may be used when the number of request power provision electric wires 3013 is greater than the number of electric wires of the intra-parking lot power grid 5000.

The relay connection power grid (c) 4030 may include a top connection power grid 4031, a middle-end connection power grid 4032, a bottom connection power grid 4033, the multi-connection switch 700, and the electric wire 900 to which the relay connection power grid and the intra-parking lot power grid are connected.

The relay connection power grids (a) to (c) 4010, 4020, and 4030 have been drawn in order to describe embodiments according to the present disclosure, and is not limited to only a corresponding structure, but may be constructed to have a polygonal structure, such as a triangle, a quadrangle, a pentagon, or a hexagon, a circle, or a stereoscopic structure.

FIG. 7D is a diagram of the relay connection power grid (d) 4040, illustrating an example when the top connection power grid 4011, 4021, and 4031 (hereinafter referred to as 4011) of the relay connection power grid 4000 is connected to the request power provision electric wire 3013 in a one-to-one way.

FIG. 7E is a diagram of the relay connection power grid (e) 4050, illustrating an example when the top connection power grid 4011 of the relay connection power grid 4000 is connected to the request power provision electric wire 3013 in a way that one request power provision electric wire 3013 is skipped per two top connection power grids 4011.

FIG. 7F is a diagram of the relay connection power grid (f) 4060, illustrating an example when the top connection power grid 4011 of the relay connection power grid 4000 is connected to the request power provision electric wire 3013 in a way that one request power provision electric wire 3013 is skipped per one top connection power grid 4011.

The relay connection power grids (d) to (f) 4040, 4050, and 4060 have been drawn in order to describe embodiments according to the present disclosure, and is not limited to only a corresponding structure, but may be variously connected, such as a method of skipping several request power provision electric wires per several top connection power grids.

FIG. 8A is a diagram of the intra-parking lot power grid (a) 5010, illustrating an example in which in the intra-parking lot power grid 5000, the electric wire 900 to which the relay connection power grid and the intra-parking lot power grid are connected is connected to a top multi-connection switch line 5011.

In general, the intra-parking lot multi-connection switch 700 may be set in a parking lot unit. The charging adapter 5015, 5025, 5035, and 5045 (hereinafter 5015) may be installed for each multi-connection switch 700. In general, the charging adapter 5015 may be installed along with the multi-connection switch 700 or near the multi-connection switch 700, but may be installed after determining a proper location of the charging adapter 5015, if necessary.

An important point is whether the number of cases of connection paths of the multi-connection switch 700 can be sufficiently secured so that a new path can be formed without a crosstalk with the paths of the charging target vehicles 9000 whose paths have already been formed and that are being charged, which are various and may be said to be randomly connected in principle, among chargeable adapters in many parking lots the number of which is much large in the request power manipulation unit 3000 having a small number of power supply lines.

As another embodiment, the request power manipulation unit 3000 may be directly connected to the intra-parking lot power grid 5000 without the relay connection power grid 4000. For example, if the intra-parking lot multi-connection switch 700 has been installed, but there are multiple places where the charging adapter 5015 is not present, if necessary, the request power manipulation unit 3000 may be directly connected to the intra-parking lot power grid 5000 through a corresponding portion. Even in this case, the reason for this is that the number of cases of a connection path for the multi-connection switches 700 can be sufficiently secured.

In other words, one core characteristic of the present disclosure is a parking space having the charging adapters 5015 the number of which is greater than the number of simultaneously chargeable electric vehicles. Preferably, almost all of parking spaces are designed to have the charging adapter 5015 or designed to have the charging adapter 5015 in the future. For example, the number of simultaneously chargeable electric vehicles may be 60, but the number of parking spaces including the charging adapter 5015 may be 500. In such a case, an internal combustion engine vehicle or an electric vehicle can be arbitrarily parked at the parking space regardless of the internal combustion engine vehicle or the electric vehicle. The electric vehicle does not need to be moved from the parking space although the electric vehicle has been fully charged.

Furthermore, a designated parking space may be set. Although an internal combustion engine vehicle is now used or an internal combustion engine vehicle is changed into an electric vehicle in the future, the same parking space can be used without any inconvenience.

Furthermore, in an apartment, in the case of an already registered resident (if a condition is satisfied although a charging wisher is not a resident), if the resident sets that charging has only to be performed until the resident goes to work next morning after getting off work in the evening, the resident can use electricity that is cheap at night while preferentially complying with an urgent request from another charging wisher, and can charge a battery with less strain on the battery by using relatively low power.

The intra-parking lot power grid (a) 5010 may be constructed to include a top multi-connection switch line 5011, a right-end multi-connection switch line 5012, a bottom multi-connection switch line 5013, a left-end multi-connection switch line 5014, the multi-connection switch 700, the charging adapter 5015, and the electric wire 900 to which the relay connection power grid and the intra-parking lot power grid are connected.

The intra-parking lot power grid 5000 is used to form a charging path up to a location of the charging target vehicle 9000 by controlling the multi-connection switch 700 disposed between electric wires that are connected to the relay connection power grid 4000 and that are intersected.

The charging adapter 5015 means an adaptor to be used for the charging of a charging target vehicle, and may be connected at a point to which the multi-connection switch 700 is connected. Although the intra-parking lot power grid 5000 is constructed within a parking lot, if the point of the multi-connection switch 700 is not a parking space, such as a road or a passage, the connection of the charging adapter 5015 may be omitted.

The charging adapter 5015 may be disposed on a ceiling or the surface of a wall, inside/outside a floor, or within a separate housing that is constructed, and may be connected to a module capable of wireless charging according to circumstances. The intra-parking lot power grid (a) 5010 may be used when a path up to a location of the charging target vehicle 9000 can be formed by using only the top multi-connection switch line 5011.

FIG. 8B is a diagram of the intra-parking lot power grid (b) 5020, illustrating an example in which in the intra-parking lot power grid 5000, the electric wire 900 to which the relay connection power grid and the intra-parking lot power grid are connected is connected to a top multi-connection switch line 5021 and a right-end multi-connection switch line 5022.

The intra-parking lot power grid (b) 5020 may include the top multi-connection switch line 5021, the right-end multi-connection switch line 5022, a bottom multi-connection switch line 5023, a left-end multi-connection switch line 5024, the multi-connection switch 700, the charging adapter 5025, and the electric wire 900 to which the relay connection power grid and the intra-parking lot power grid are connected.

The intra-parking lot power grid (b) 5020 may be used if it is difficult to form a path up to a location of the charging target vehicle 9000 by using only the top multi-connection switch line 5011 in the intra-parking lot power grid (a) 5010.

The intra-parking lot power grid (b) 5020 may supply a charging speed (requested power) up to the charging target vehicle 9000 along various paths, compared to the intra-parking lot power grid (a) 5010, by using the top multi-connection switch line 5021 and the right-end multi-connection switch line 5022.

FIG. 8C is a diagram of the intra-parking lot power grid (c) 5030, illustrating an example in which in the intra-parking lot power grid 5000, the electric wire 900 to which the relay connection power grid and the intra-parking lot power grid are connected is connected to a top multi-connection switch line 5031, a right-end multi-connection switch line 5032, and a left-end multi-connection switch line 5034.

The intra-parking lot power grid (c) 5030 may be constructed to include the top multi-connection switch line 5031, the right-end multi-connection switch line 5032, a bottom multi-connection switch line 5033, the left-end multi-connection switch line 5034, the multi-connection switch 700, the charging adapter 5035, and the electric wire 900 to which the relay connection power grid and the intra-parking lot power grid are connected.

The intra-parking lot power grid (c) 5030 can supply a charging speed (requested power) up to the charging target vehicle 9000 by forming more various paths by additionally connecting the left-end multi-connection switch line 5034 to the electric wire 900 to which the relay connection power grid and the intra-parking lot power grid are connected, in the construction of the intra-parking lot power grid (b) 5020.

FIG. 8D is a diagram of the intra-parking lot power grid (d) 5040, illustrating an example when the electric wire 900 to which the relay connection power grid and the intra-parking lot power grid are connected is connected to a top multi-connection switch line 5041, a right-end multi-connection switch line 5042, and a left-end multi-connection switch line 5044, but an obstacle, such as a wall, is present halfway, in the intra-parking lot power grid 5000.

The intra-parking lot power grid (d) 5040 forms a path and provides a charging speed (requested power) in the same manner as the intra-parking lot power grid (c) 5030, and illustrating an example in which the power grid is formed by excluding an obstacle if the obstacle such as a wall is present. A form of the power grid may be different depending on a form of the obstacle.

The intra-parking lot power grid (d) 5040 illustrates a case in which an obstacle is present in a central part of a lower part of the intra-parking lot power grid (d) 5040, and is merely a diagram according to an embodiment of the present disclosure. The present disclosure is not limited to the corresponding structure, and a form of the power grid may be various.

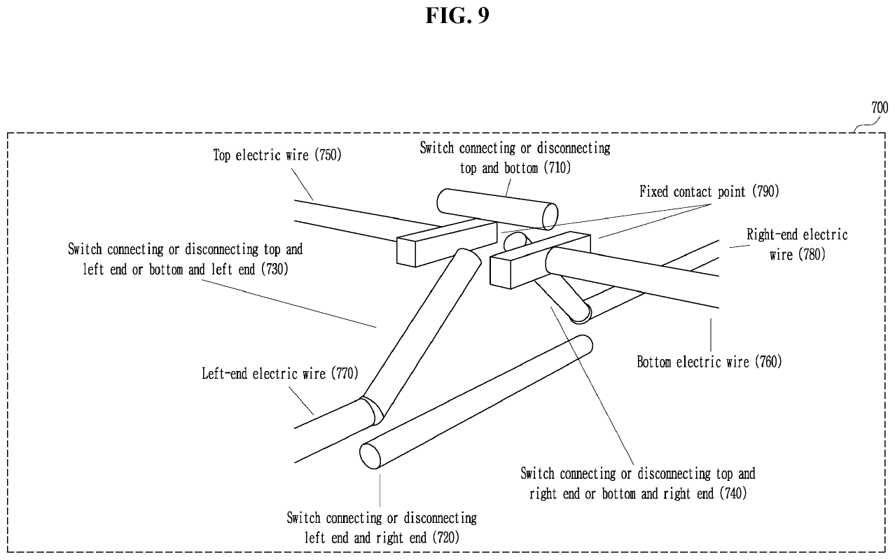

FIG. 9 is a diagram illustrating an example of an internal structure of the multi-connection switch, and is an example for describing how the multi-connection switch 700 operates. The present disclosure is not limited to the corresponding structure, and may have various structures that play the same role.

The multi-connection switch 700 may include a top electric wire 750, a bottom electric wire 760, a left-end electric wire 770, a right-end electric wire 780, a fixed contact point 790, a switch 710 that connects or disconnects the top and the bottom, a switch 720 that connects or disconnects the left end and the right end, a switch 730 that connects or disconnects the top and the left end or the bottom and the left end, and a switch 740 that connects or disconnects the top and the right end or the bottom and the right end.

The multi-connection switch 700 may be variously connected or disconnected depending on operations of internal switches. FIGS. 10A to 10G are examples illustrating, as a diagram, examples (a) to (g) in which the multi-connection switch is connected.

FIGS. 10A to 10G disclose a square that has the number of cases of a connection and that is continued left and right and up and down as a shape of the connection of the multi-connection switch that is used in the present disclosure as one embodiment. However, this is for sufficiently securing the number of cases of connection paths of the multi-connection switch so that a new path can be formed without a crosstalk with the paths of the charging target vehicles whose paths have already been formed and that are being charged, which are various and may be said to be randomly connected in principle, among chargeable adapters in many parking lots the number of which is much large in the request power manipulation unit having a small number of power supply lines. In the multi-connection switches of the present disclosure, a width for the selection of a connection and change may be at least two.

Therefore, as an embodiment, FIGS. 10A to 10G illustrate one embodiment. If the number of cases is sufficiently secured by only a smaller number of switches according to circumstances or based on continued experiences, the number of cases may be adjusted and selected by those skilled in the art.

Furthermore, the multi-connection switches may be connected as a triangle, a hexagon, etc. in which the multi-connection switches are connected in all directions, not squares that are continued. Alternatively, the multi-connection switches may also be connected as a three-dimensional connection structure. For example, the multi-connection switches may have a regular tetrahedron or a regular hexahedron that is connected in multiple directions. A shape of the multi-connection switches may be slightly crushed and used, if necessary. Furthermore, these shapes may be mixed and used.

An important core is whether the number of cases of connection paths of the multi-connection switches can be sufficiently secured so that a new path can be formed without a crosstalk with the paths of the charging target vehicles whose paths have already been formed and that are being charged, which are various and may be said to be randomly connected in principle, among chargeable adapters in many parking lots the number of which is much large in the request power manipulation unit having a small number of power supply lines.

As another embodiment, the request power manipulation unit may be directly connected to the intra-parking lot power grid without the relay connection power grid. For example, the intra-parking lot multi-connection switch is installed, but the request power manipulation unit may be directly connected to the intra-parking lot power grid through multiple portions in which a charging adapter is not present, if necessary. Even in this case, the reason for this is that the number of cases of a connection path for the multi-connection switches can be sufficiently secured.

FIG. 10A is an example illustrating an example in the state in which the internal switches of the multi-connection switch 700 have been released. FIG. 10B is an example in which the switch 710 that connects or disconnects the top and the bottom, among the internal switches, is connected to two fixed contact points 780 and thus the top electric wire 750 and the bottom electric wire 760 have been connected.

FIG. 10C is an example in which the switch 720 that connects or disconnects the left end and the right end, among the internal switches, is connected to the left-end electric wire 770 and the right-end electric wire 780 and thus the left-end electric wire 770 and the right-end electric wire 780 have been connected.

FIG. 10D is an example in which the switch 730 that connects or disconnects the top and the left end or the bottom and the left end, among the internal switches, is connected to the fixed contact point 790 of the top electric wire 750 and thus the top electric wire 750 and the left-end electric wire 770 have been connected.

FIG. 10E is an example in which the switch 730 that connects or disconnects the top and the left end or the bottom and the left end, among the internal switches, is connected to the fixed contact point 790 of the bottom electric wire 760 and thus the bottom electric wire 760 and the left-end electric wire 770 have been connected.

FIG. 10F is an example in which the switch 740 that connects or disconnects the top and the right end or the bottom and the right end, among the internal switches, is connected to the fixed contact point 790 of the top electric wire 750 and thus the top electric wire 750 and the right-end electric wire 780 have been connected.

FIG. 10G is an example in which the switch 740 that connects or disconnects the top and the right end or the bottom and the right end, among the internal switches, is connected to the fixed contact point 790 of the bottom electric wire 760 and thus the bottom electric wire 760 and the right-end electric wire 780 have been connected.

FIGS. 9, and 10A to 10G are diagrams for describing operating methods of the multi-connection switch 700. The structure of the multi-connection switch 700 is not limited to only a corresponding structure, and may be constructed as various structures that play the same role.

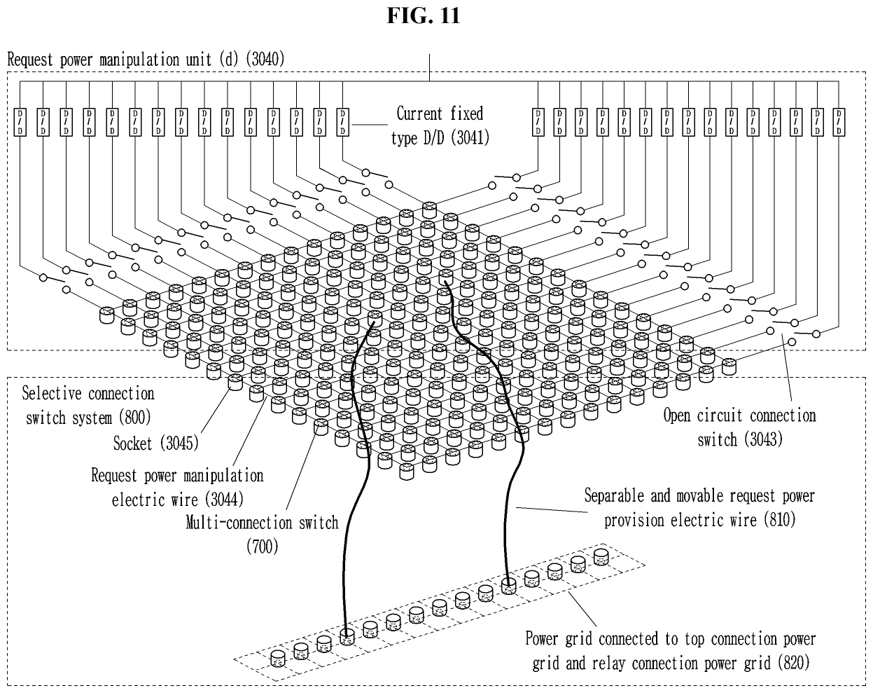

FIG. 11 is a diagram illustrating an example of the selective connection switch system. The selective connection system 800 may be constructed between the request power manipulation unit (d) 3040 and the relay connection power grid (c) 4030.

The socket 3045 of the request power manipulation unit (d) 3040 and the socket 3045 of the power grid 820 that is connected to the top connection power grid of the relay connection power grid of the selective connection switch system 800 is connected to the separable and movable request power provision electric wire 810.

The separable and movable request power provision electric wire 810 may be connected by using a magnet or may be connected in a plug form. A corresponding electric wire may be directly connected by a person along a formed path, or a robot, a machine, etc. may be constructed to perform a task for disconnecting, moving, and connecting the electric wire along the path.

FIG. 11 is a diagram for describing an example of the selective connection switch system according to an embodiment of the present disclosure. The structure of the selective connection switch system 800 is not limited to only a corresponding structure, and may be constructed as another structure that plays the same role depending on a structure upon installation.

1. A charging system for an electric vehicle, which enables a charging wisher to autonomously select a charging location, the charging system comprising:
an AC/DC converting system;
a request power manipulation unit comprising DC/DC converters corresponding to a maximum number of simultaneously chargeable electric vehicles and an open circuit connection switch and a request power provision electric wire for each DC/DC converter;
a charging adapter selectively installed in each parking space; and
a connection power grid capable of connecting the request power provision electric wire and the charging adapters between the request power provision electric wire and the charging adapters,
wherein multiple edges at which three or more electric wires are able to selectively form a contact point are formed in the connection power grid,
a multi-connection switch is installed at an edge selected among the edges, and
a path is able to be selectively set in any one direction of electric wires among multiple directions in which the electric wires are connected to the multi-connection switch through control of the multi-connection switch.

2. The charging system of claim 1, wherein a space in which any one or more of the AC/DC converting system, a request power manipulation unit, the charging adapter, and the multi-connection switch are able to be further installed is secured in preparation for a future increase in the maximum number of simultaneously chargeable electric vehicles.

3. The charging system of claim 1, further comprising any one or more of a new renewable generator and an energy storage system (ESS) as a power supply source.

4. The charging system of claim 1, wherein the number of DC/DC converters is 0.8 to 2.5 times the maximum number of simultaneously chargeable electric vehicles.

5. The charging system of claim 1, wherein a form of the connection power grid is a polygon, a polyhedron, or a form in which a complex thereof is connected.

6. The charging system of claim 5, wherein the form of the connection power grid is a triangle, a quadrangle, or a hexagon and is able to be connected in multiple directions.

7. The charging system of claim 1, wherein the number of charging adapters is 2 to 30 times the maximum number of simultaneously chargeable electric vehicles.

8. The charging system of claim 1, wherein the connection power grid comprises a relay connection power grid and an intra-parking lot power grid.

9. The charging system of claim 1, wherein the multi-connection switch is installed in 50% or more of the edges that are formed in the connection power grid.

10. The charging system of claim 1, further comprising a main control apparatus,
wherein the main control apparatus comprises one or more of charging electric-wire connection management functions for an allowed power quantity management apparatus, AC/DC converting system management, current fixed type or variable type DC/DC converter management, relay connection power grid management, and intra-parking lot power grid management.

11. The charging system of claim 1, further comprising a main control apparatus comprising a billing system, a member information management system, and a charging target vehicle charging and information management function.

12. A method of charging an electric vehicle, which enables a charging wisher to select a charging location, the method comprising:
delivering, by a charging wisher, charging intention to a charging system for an electric vehicle, which enables a charging wisher to select a charging location;
receiving and determining, by the charging system, the charging intention;
entering, by an electric vehicle of the charging wisher, a space equipped with a charging adapter;
connecting, by the electric vehicle of the charging wisher, to the charging adapter;
determining, by the charging system, a DC/DC converter of corresponding charging power;
forming a charging electric wire of a connection power grid from a corresponding request power provision electric wire of the corresponding DC/DC converter to the corresponding charging adapter;
connecting a corresponding open circuit connection switch of the corresponding DC/DC converter;
charging the corresponding electric vehicle;
terminating the charging of the corresponding electric vehicle; and
opening the corresponding open circuit connection switch of the corresponding DC/DC converter.

13. The method of claim 12, wherein the forming of the charging electric wire of the connection power grid from the corresponding request power provision electric wire of the corresponding DC/DC converter to the corresponding charging adapter is performed earlier than the connecting of the corresponding open circuit connection switch of the corresponding DC/DC converter.

14. The method of claim 12, further comprising releasing the charging electric wire of the connection power grid up to the corresponding request power provision electric wire of the corresponding DC/DC converter and the corresponding charging adapter.

15. The method of claim 14, wherein the opening of the corresponding open circuit connection switch of the corresponding DC/DC converter is performed earlier than the releasing of the charging electric wire of the connection power grid up to the corresponding request power provision electric wire of the corresponding DC/DC converter and the corresponding charging adapter.

16. The method of claim 12, wherein:
the charging wisher is able to deliver charging intention comprising a desired charging departure time, and
although charging is completed prior to the desired charging departure time, an adaptor is in a state in which the adaptor has been connected to the electric vehicle.

17. The method of claim 12, further comprising providing the charging wisher with information comprising one or more of a charging waiting time, charging charges, a charging speed, a charging time, and a location of a charging space.

18. The method of claim 12, further comprising denying, by the charging system, charging when the charging intention of the charging wisher and suitability of the electric vehicle are mismatched by determining the charging intention and the suitability.
